(19) United States
(12) Patent Application Publication
(10) Pub. No.: US 2024/0296569 A1
(43) Pub. Date: Sep. 5, 2024

(54) IMAGING SYSTEM AND IMAGING METHOD

(71) Applicant: Panasonic Intellectual Property Management Co., Ltd., Osaka (JP)

(72) Inventors: YUMIKO KATO, Osaka (JP); MOTOKI YAKO, Osaka (JP); SHUNSUKE YASUGI, Osaka (JP)

(21) Appl. No.: 18/661,356

(22) Filed: May 10, 2024

Related U.S. Application Data
(63) Continuation of application No. PCT/JP2022/042583, filed on Nov. 16, 2022.

(30) Foreign Application Priority Data
Dec. 3, 2021 (JP) 2021-197194

(51) Int. Cl. G06T 7/215; G01J 3/28; G06T 7/90; H04N 5/14

(52) U.S. Cl. CPC G06T 7/215; G01J 3/2823; G06T 7/90; H04N 5/144; G01J 2003/2806; G01J 2003/2826; G06T 2207/10024

(57) ABSTRACT

An imaging system includes an imaging apparatus that repeatedly acquires a compressed image in which information regarding light of four or more wavelength bands from a target is compressed, and a processing apparatus. The processing apparatus extracts a partial region including a region of the target from the compressed image so as to compensate for a relative motion between the target and the imaging apparatus, and generates spectral images corresponding to wavelength bands, based on data of the partial region of the compressed image.

### BACKGROUND

### 1. Technical Field

The present disclosure relates to an imaging system and an imaging method.

### 2. Description of the Related Art

Hyperspectral imaging apparatuses, which acquire image data allowing detailed color representation beyond that achievable through the combination of RGB (red, green, and blue), are used in various fields. There are existing hyperspectral imaging methods in which, for example, prisms or diffraction gratings are used to sequentially acquire detailed spectral information line by line while scanning a measurement target region in one direction. Another method is to acquire images of different wavelength ranges sequentially by switching optical filters having different transmission wavelength ranges and capturing images sequentially. These methods take time for imaging because the information is acquired sequentially over space or spectrum.

U.S. Pat. No. 9,599,511 discloses an example of a hyperspectral imaging apparatus using compressed sensing. The imaging apparatus disclosed in U.S. Pat. No. 9,599,511 includes an encoding element, which is an array of optical filters having different spectral transmittances from each other, along the optical path connecting a target and the image sensor. Images of wavelength bands can be generated through single imaging by performing reconstruction calculation based on compressed images acquired through imaging using the encoding element. According to U.S. Pat. No. 9,599,511, a video based on hyperspectral images can be generated.

International Publication No. 2019/054092 discloses a method for reducing the load of image data reconstruction processing using compressed sensing by performing reconstruction calculation only on regions in images where objects are identified.

Japanese Unexamined Patent Application Publication No. 2019-12869 discloses a method for reducing the load of image data reconstruction processing using compressed sensing by reconstructing only the regions of acquired compressed images where luminance has changed over time.

International Publication No. 2015/200038 discloses a method for generating, in accordance with video data acquired by performing compressed sensing imaging and data indicating camera motion at the time of image acquisition detected by a sensor, a kernel matrix corresponding to the motion and suppressing image blurring due to the motion on the basis of the kernel matrix.

### SUMMARY

One non-limiting and exemplary embodiment provides a method for reducing the load of arithmetic processing for generating images of wavelength bands with reduced blur.

In one general aspect, the techniques disclosed here feature an imaging system that includes an imaging apparatus that acquires a compressed image in which information regarding light of four or more wavelength bands from a target is compressed, and a processing apparatus. The processing apparatus extracts a partial region including a region of the target from the compressed image so as to compensate for a relative motion between the target and the imaging apparatus, and generates spectral images corresponding to wavelength bands, based on data of the partial region of the compressed image.

According to an aspect of the present disclosure, the load of arithmetic processing for generating images of wavelength bands with reduced blur can be reduced.

It should be noted that general or specific embodiments may be implemented as a system, an apparatus, a method, an integrated circuit, a computer program, a computer readable recording medium, or any selective combination thereof. Examples of the computer readable recording medium include a nonvolatile recording medium such as a compact disc read-only memory (CD-ROM). The apparatus may be formed by one or more devices. In a case where the apparatus is formed by two or more devices, the two or more devices may be arranged in one apparatus or may be arranged in two or more separate apparatuses in a divided manner. In the present specification and the claims, an “apparatus” may refer not only to one apparatus but also to a system formed by apparatuses.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram schematically illustrating an example of an imaging system;

FIG. 1B is a diagram schematically illustrating another example of the imaging system;

FIG. 1C is a diagram schematically illustrating yet another example of the imaging system;

FIG. 1D is a diagram schematically illustrating yet another example of the imaging system;

FIG. 2A is a diagram schematically illustrating an example of a filter array;

FIG. 2B is a diagram illustrating, regarding light of individual wavelength bands, an example of a spatial distribution of transmittance of the filter array;

FIG. 2C is a diagram illustrating an example of the spectral transmittance of a certain region included in the filter array;

FIG. 2D is a diagram illustrating an example of the spectral transmittance of another region included in the filter array;

FIG. 3A is a diagram for describing the relationship between a target wavelength range and wavelength bands included in the target wavelength range;

FIG. 3B is another diagram for describing the relationship between the target wavelength range and the wavelength bands included in the target wavelength range;

FIG. 4A is a diagram for describing characteristics of the spectral transmittance of a certain region of the filter array;

FIG. 4B is a diagram illustrating a result obtained by averaging spectral transmittances of each of the wavelength bands illustrated in FIG. 4A;

FIG. 5 is a block diagram illustrating the configuration of an imaging system according to a first embodiment;

FIG. 6 is a flowchart illustrating the operation of the imaging system;

FIG. 7A is a first diagram for describing the amounts of correction of an image and its calculation method;

FIG. 7B is a second diagram for describing the amounts of correction of the image and its calculation method;

FIG. 7C is a third diagram for describing the amounts of correction of the image and its calculation method;

FIG. 8 is a flowchart illustrating a detailed example of the operation in Step S1400;

FIG. 9 is a block diagram illustrating the configuration of an imaging system according to a first modification of the first embodiment;

FIG. 10 is a flowchart illustrating the operation of the imaging system according to the first modification of the first embodiment;

FIG. 11 is a flowchart illustrating a more detailed example of the operation in Step S2500;

FIG. 12 is a flowchart illustrating part of the operation of a processing apparatus according to a second modification of the first embodiment;

FIG. 13 is a flowchart illustrating part of the operation of a processing apparatus according to a third modification of the first embodiment;

FIG. 14 is a block diagram illustrating the configuration of an imaging system according to a second embodiment;

FIG. 15 is a flowchart illustrating the operation of an imaging system according to the second embodiment;

FIG. 16 is a diagram illustrating an example of the configuration of an imaging system in which an imaging apparatus and a processing apparatus are installed at locations apart from each other;

FIG. 17 is a flowchart illustrating the operation of an imaging system according to the present modification;

FIG. 18 is a diagram illustrating the relationship between a first image Ig1, a matrix g1′, and a matrix g1;

FIG. 19 is a diagram illustrating the relationship between the first image Ig1 and an image I(1k);

FIG. 20 is a diagram illustrating the relationship between a second image Ig2, a matrix g2′, and a matrix g2; and

FIG. 21 is a diagram illustrating the relationship between the second image Ig2 and an image I(2k).

### DETAILED DESCRIPTIONS

In the present disclosure, all or some of circuits, units, devices, members, or portions or all or some of the functional blocks of a block diagram may be executed by, for example, one or more electronic circuits including a semiconductor device, a semiconductor integrated circuit (IC), or a large-scale integration circuit (LSI). The LSI or the IC may be integrated onto one chip or may be formed by combining chips. For example, functional blocks other than a storage device may be integrated onto one chip. In this case, the term LSI or IC is used; however, the term(s) to be used may change depending on the degree of integration, and the term system LSI, very large-scale integration circuit (VLSI), or ultra-large-scale integration circuit (ULSI) may be used. A field-programmable gate array (FPGA) or a reconfigurable logic device (RLD) that allows reconfiguration of interconnection inside the LSI or setup of a circuit section inside the LSI can also be used for the same purpose, the FPGA and the RLD being programmed after the LSIs are manufactured.

Furthermore, functions or operations of all or some of the circuits, the units, the devices, the members, or the portions can be executed through software processing. In this case, the software is recorded in one or more non-transitory recording mediums, such as a read-only memory (ROM), an optical disc, or a hard disk drive, and when the software is executed by a processing apparatus (a processor), the function specified by the software is executed by the processing apparatus and peripheral devices. The system or the apparatus may include the one or more non-transitory recording mediums in which the software is recorded, the processing apparatus, and a hardware device to be needed, such as an interface.

First, an example of the configuration of an imaging system according to an embodiment of the present disclosure and the findings found by the inventors will be described.

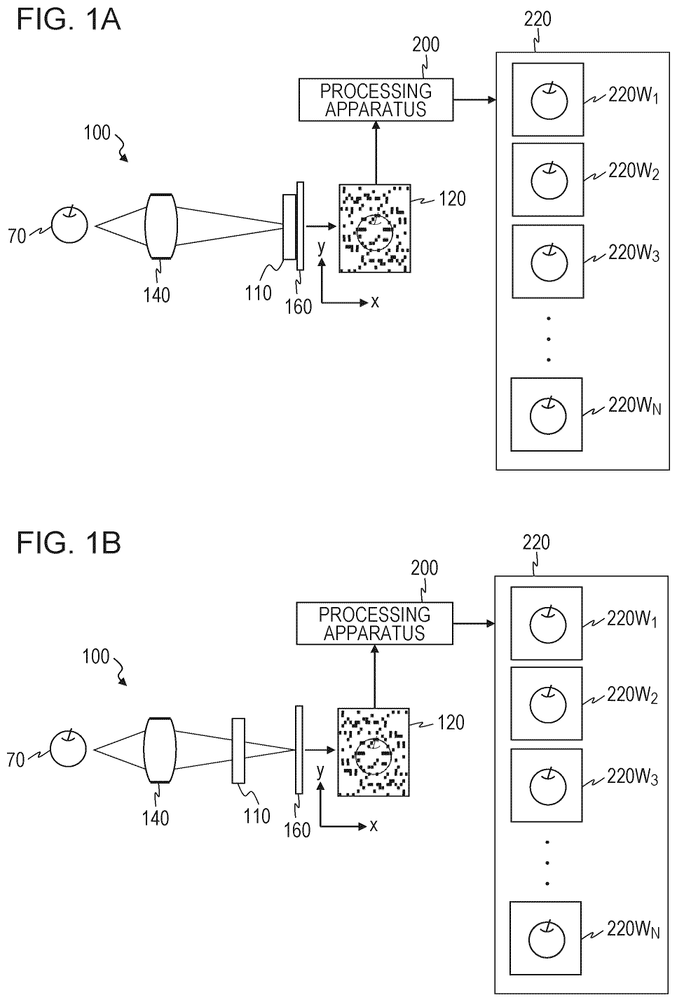

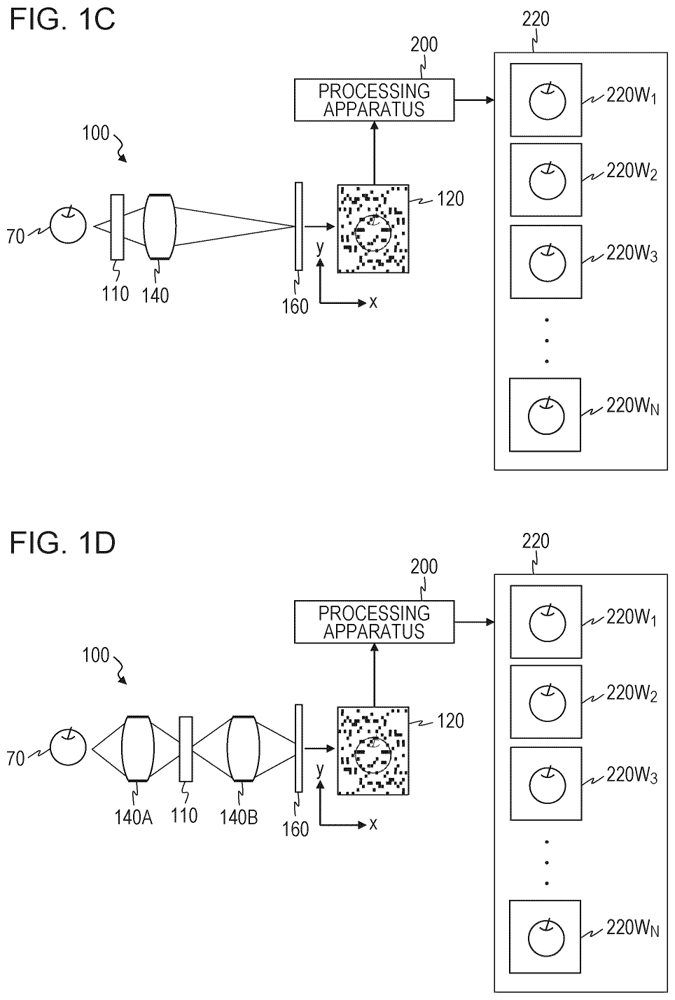

FIG. 1A is a diagram schematically illustrating an example of an imaging system. This system includes an imaging apparatus 100 and a processing apparatus 200. The imaging apparatus 100 has substantially the same configuration as the imaging apparatus disclosed in U.S. Pat. No. 9,599,511. The imaging apparatus 100 includes a filter array 110, an optical system 140, and an image sensor 160. The filter array 110 has substantially the same structure and function as the “encoding element” disclosed in U.S. Pat. No. 9,599,511. The optical system 140 and the filter array 110 are disposed along an optical path of incident light from a target 70, which is a subject. The filter array 110 is disposed between the optical system 140 and the image sensor 160.

FIG. 1A illustrates an apple as an example of the target 70. The target 70 is not limited to an apple, and may be any object. The image sensor 160 generates data of a compressed image 120, which is obtained by compressing information regarding wavelength bands into a single two-dimensional monochrome image. The processing apparatus 200 generates image data of each of the wavelength bands included in a certain target wavelength range, on the basis of the data of the compressed image 120 generated by the image sensor 160. These generated image data corresponding to the wavelength bands on a one-to-one basis will be referred to as “hyperspectral image data” in this specification. In this case, suppose that the number of wavelength bands included in the target wavelength range is N (N is an integer greater than or equal to four). In the following description, the generated image data corresponding to the wavelength bands on a one-to-one basis will be referred to as a spectral image 220W₁, a spectral image 220W₂, . . . , a spectral image 220W_{N}, and these images are collectively referred to as a hyperspectral image 220. In this specification, a signal representing an image, that is, a group of signals representing pixel values of pixels may be simply referred to as an “image”.

The filter array 110 is an array of filters disposed in rows and columns and having translucency. The filters include different kinds of filters having different spectral transmittances from each other, that is, having different wavelength dependencies on luminous transmittance from each other. The filter array 110 modulates the intensity of incident light on a wavelength basis and outputs the resulting light. This process performed by the filter array 110 will be referred to as “encoding” in this specification.

In the example illustrated in FIG. 1A, the filter array 110 is disposed near or directly on the image sensor 160. In this case, “near” refers to the filter array 110 being close enough to the image sensor 160 that an image of light from the optical system 140 is formed on the surface of the filter array 110 in a state where the image of light has a certain degree of clearness. “Directly on” refers to the filter array 110 and the image sensor 160 being close to each other to an extent that there is hardly any gap therebetween. The filter array 110 and the image sensor 160 may be formed as a single device.

The optical system 140 includes at least one lens. In FIG. 1A, the optical system 140 is illustrated as one lens; however, the optical system 140 may be a combination of lenses. The optical system 140 forms an image on an imaging surface of the image sensor 160 through the filter array 110.

The filter array 110 may be disposed so as to be spaced apart from the image sensor 160. FIGS. 1B to 1D are diagrams illustrating examples of the configuration of the imaging apparatus 100, in which the filter array 110 is disposed so as to be spaced apart from the image sensor 160. In the example illustrated in FIG. 1B, the filter array 110 is disposed between the optical system 140 and the image sensor 160 and at a position spaced apart from the image sensor 160. In the example illustrated in FIG. 1C, the filter array 110 is disposed between the target 70 and the optical system 140. In the example illustrated in FIG. 1D, the imaging apparatus 100 includes two optical systems 140A and 140B, and the filter array 110 is disposed between the optical systems 140A and 140B. As in these examples, an optical system including one or more lenses may be disposed between the filter array 110 and the image sensor 160.

The image sensor 160 is a monochrome light detector having light detection devices (also referred to as “pixels” in this specification) arranged two-dimensionally. The image sensor 160 may be, for example, a charge-coupled device (CCD), a complementary metal-oxide-semiconductor (CMOS) sensor, an infrared array sensor, a terahertz array sensor, or a millimeter-wave array sensor. The light detection devices include, for example, a photodiode. The image sensor 160 is not necessarily a monochrome sensor. For example, a color sensor having R/G/B filters (a filter transmitting red light, a filter transmitting green light, and a filter transmitting blue light), R/G/B/IR filters (a filter transmitting red light, a filter transmitting green light, and a filter transmitting infrared rays), or R/G/B/W filters (a filter transmitting red light, a filter transmitting green light, and a filter transmitting white light) may be used. By using the color sensor, the amount of information regarding wavelengths can be increased, so that the generation accuracy of a hyperspectral image 220 can be increased. A wavelength region as an acquisition target may be freely determined. The wavelength region is not limited to the visible wavelength region and may also be the ultraviolet wavelength region, the near infrared wavelength region, the mid-infrared wavelength region, the far-infrared wavelength region, or the microwave and radio wave wavelength range.

The processing apparatus 200 is a computer including a processor and a storage medium, such as a memory. The processing apparatus 200 generates, on the basis of the compressed image 120 acquired by the image sensor 160, data of the spectral image 220W₁ including information regarding a wavelength band W₁, data of the spectral image 220W₂ including information regarding a wavelength band W₂, . . . , and data of the spectral image 220W_{N} including information regarding a wavelength band W_{N}.

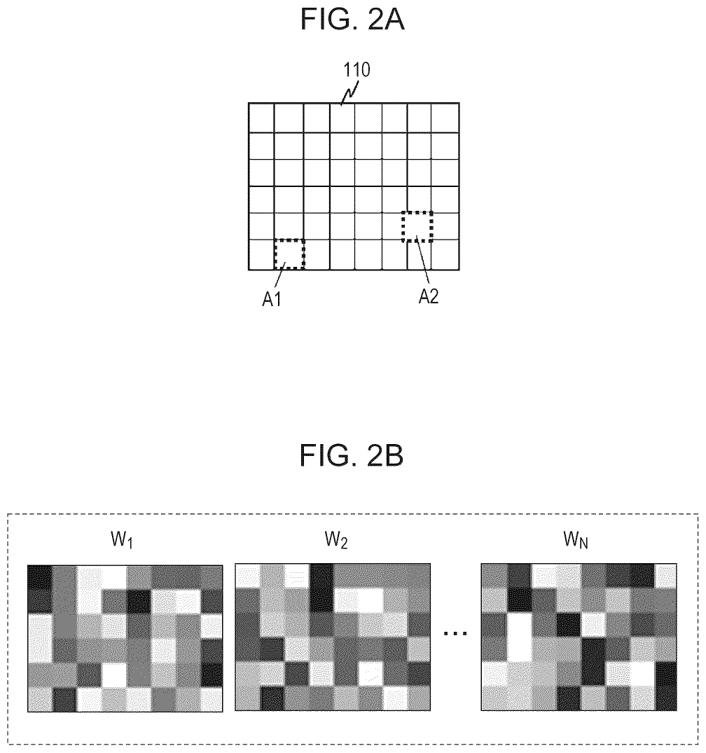

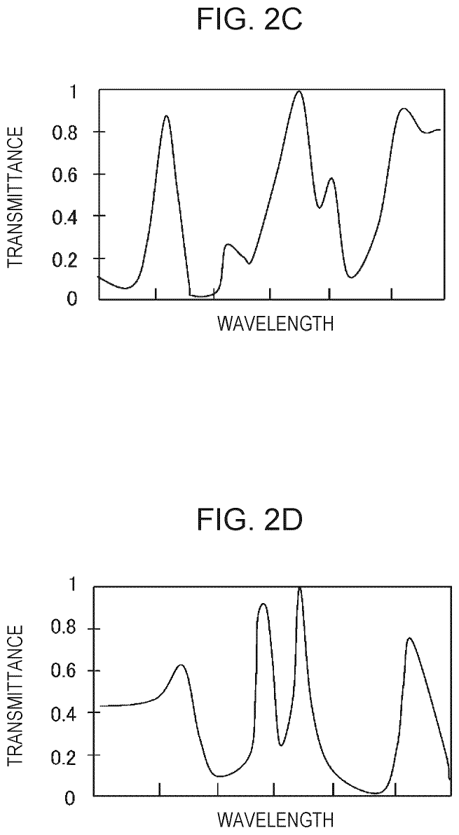

FIG. 2A is a diagram schematically illustrating an example of the filter array 110. The filter array 110 has regions arranged two-dimensionally. In this specification, these regions may be referred to as “cells”. In each region, an optical filter having a spectral transmittance set individually is arranged. Spectral transmittance is expressed by a function T(λ), where the wavelength of incident light is λ. The spectral transmittance T(λ) may have a value greater than or equal to 0 and less than or equal to 1.

In the example illustrated in FIG. 2A, the filter array 110 has 48 rectangular regions arranged in 6 rows and 8 columns. This is merely an example, and a larger number of regions than this may be provided in actual applications. The number of regions may be about the same as, for example, the number of pixels of the image sensor 160. The number of filters included in the filter array 110 is determined in accordance with applications, for example, within a range from several tens to several tens of millions.

FIG. 2B includes diagrams illustrating an example of a spatial distribution of luminous transmittance of each of the wavelength bands W₁, W₂, . . . , W_{N} included in the target wavelength range. In the example illustrated in FIG. 2B, differences in shading between the regions represent differences in transmittance. The lighter the shade of the region, the higher the transmittance. The darker the shade of the region, the lower the transmittance. As illustrated in FIG. 2B, the spatial distribution of luminous transmittance differs depending on a wavelength band basis.

FIG. 2C is a diagram illustrating an example of the spectral transmittance of a region A1, and FIG. 2D is a diagram illustrating an example of the spectral transmittance of a region A2, the regions A1 and A2 being included in the filter array 110 illustrated in FIG. 2A. The spectral transmittance of the region A1 is different from that of the region A2. In this manner, the spectral transmittance of the filter array 110 differs on a region basis. Note that all the regions do not necessarily have different spectral transmittances from each other. At least some of the regions included in the filter array 110 have different spectral transmittances from each other. The filter array 110 includes two or more filters that have different spectral transmittances from each other. In one example, the number of patterns of spectral transmittances of the regions included in the filter array 110 may be the same as N, which is the number of wavelength bands included in the target wavelength range, or higher than N. The filter array 110 may be designed such that more than half of the regions have different spectral transmittances from each other.

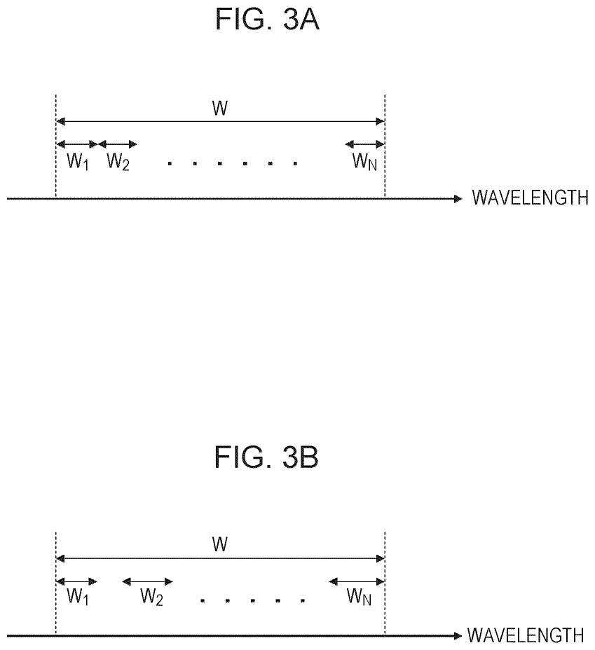

FIGS. 3A and 3B are diagrams for describing relationships between a target wavelength range W and the wavelength bands W₁, W₂, . . . , W_{N} included in the target wavelength range W. The target wavelength range W may be set to various ranges depending on applications. The target wavelength range W may have, for example, a wavelength range of visible light of about 400 nm to about 700 nm, a wavelength range of near infrared rays of about 700 nm to about 2500 nm, or a wavelength range of near ultraviolet rays of about 10 nm to about 400 nm. Alternatively, the target wavelength range W may be a wavelength range of mid-infrared rays, that of far-infrared rays, that of terahertz waves, or a radio wave range for millimeter waves. In this manner, the wavelength range to be used is not limited to the visible light range. In this specification, not only visible light but also invisible light including, for example, near ultraviolet rays, near-infrared rays, and radio waves will be referred to as “light” for convenience′ sake.

In the example illustrated in FIG. 3A, N is set to any integer greater than or equal to 4, the target wavelength range W is equally divided into N sections, and these N wavelength regions are referred to as the wavelength bands W₁, W₂, . . . , and W_{N}. Note that the example is not limited to this one. The wavelength bands included in the target wavelength range W may be freely set. For example, the wavelength bands may have different bandwidths. There may be an overlap or a gap between adjacent wavelength bands among the wavelength bands. In the example illustrated in FIG. 3B, the wavelength bands have different bandwidths, and there is a gap between two adjacent wavelength bands among the wavelength bands. In this manner, the wavelength bands may be freely determined as long as the wavelength bands are different from each other.

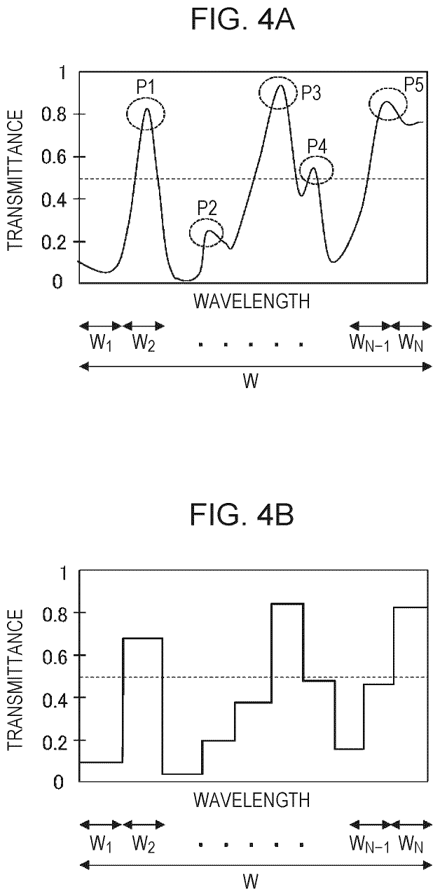

FIG. 4A is a diagram for describing characteristics of the spectral transmittance of a certain region of the filter array 110. In the example illustrated in FIG. 4A, regarding the wavelengths within the target wavelength range W, the spectral transmittance has local maxima (namely, local maxima P1 to P5) and local minima. In the example illustrated in FIG. 4A, the luminous transmittance within the target wavelength range W is normalized to have a maximum value of 1 and a minimum value of 0. In the example illustrated in FIG. 4A, the spectral transmittance has local maxima in wavelength ranges, such as the wavelength band W₂ and the wavelength band W_{N-1}. In this manner, the spectral transmittance of each region of at least two wavelength ranges among the wavelength bands W₁ to W_{N} may have a local maximum. In the example illustrated in FIG. 4A, the local maximum P1, the local maximum P3, the local maximum P4, and the local maximum P5 are greater than or equal to 0.5.

As described above, the luminous transmittance of each region varies with wavelength. Thus, each region of the filter array 110 allows a large amount of a certain wavelength range component of incident light to pass therethrough but does not allow a large portion of another wavelength range component of incident light to pass therethrough. For example, the luminous transmittances of k wavelength bands out of N wavelength bands may be greater than 0.5, and the luminous transmittances of the other N-k wavelength bands may be less than 0.5, where k is an integer that satisfies 2≤ k<N. If incident light is white light, which includes all the visible light wavelength components equally, the filter array 110 modulates, on a region basis, the incident light into light having discrete peaks in intensity for wavelengths and superposes and outputs light of these multiple wavelengths.

FIG. 4B is a diagram illustrating, as one example, a result obtained by averaging spectral transmittances of each of the wavelength band W₁, the wavelength band W₂, . . . , and the wavelength band W_{N}, the spectral transmittances being illustrated in FIG. 4A. The average transmittance is obtained by integrating the spectral transmittance T(λ) for each wavelength band and performing division using the bandwidth of the wavelength band. In this specification, the value of average transmittance for each wavelength band obtained in this manner will be treated as the transmittance of the wavelength band. In this example, transmittance is prominently high in three wavelength ranges corresponding to the local maxima P1, P3, and P5. In particular, transmittance is higher than 0.8 in the two wavelength ranges corresponding to the local maxima P3 and P5.

In the example illustrated in FIGS. 2A to 2D, a gray scale transmittance distribution is assumed in which the transmittance of each region may have any value greater than or equal to 0 and less than or equal to 1. However, a gray scale transmittance distribution is not always needed. For example, a binary scale transmittance distribution may be used in which the transmittance of each region may have either a value of around 0 or a value of around 1. In a binary scale transmittance distribution, each region allows a large portion of light of at least two wavelength ranges among the wavelength ranges included in the target wavelength range to pass therethrough, and does not allow a large portion of light of the other wavelength ranges to pass therethrough. In this case, the “large portion” refers to about 80% or higher.

Some of all the cells, for example, half the cells may be replaced with transparent regions. Such transparent regions allow light of all the wavelength bands W₁ to W_{N} included in the target wavelength range W to pass therethrough at similarly high transmittances, for example, 80% or higher. With such a configuration, the transparent regions may be disposed, for example, in a checkerboard manner. That is, the regions whose luminous transmittance varies with wavelength and the transparent regions may be arranged in an alternating manner in two directions of the arrayed regions in the filter array 110.

Data representing such a spatial distribution of the spectral transmittance of the filter array 110 is acquired beforehand on the basis of design data or by performing actual measurement calibration, and is stored in a storage medium of the processing apparatus 200. This data is used in arithmetic processing to be described later.

The filter array 110 may be formed using, for example, a multi-layer film, an organic material, a diffraction grating structure, or a microstructure including metal. In a case where a multi-layer film is used, for example, a dielectric multi-layer film or a multi-layer film including a metal layer may be used. In this case, the cells are formed such that at least one of the thicknesses, materials, and stacking orders of the layers of the multi-layer film are made different from cell to cell. As a result, spectral characteristics that are different from cell to cell can be realized. By using a multi-layer film, a sharp rising edge and a sharp falling edge can be realized for spectral transmittance. A configuration using an organic material can be realized by causing different cells to contain different pigments or dyes or by causing different cells to have stacks of layers of different materials. A configuration using a diffraction grating structure can be realized by causing different cells to have structures with different diffraction pitches or different depths. In a case where a microstructure including metal is used, the filter array 110 can be produced using plasmon effect spectroscopy.

Next, an example of signal processing performed by the processing apparatus 200 will be described. The processing apparatus 200 generates a hyperspectral image 220, which is a multi-wavelength image, on the basis of a compressed image 120 output from the image sensor 160 and characteristics of a transmittance spatial distribution for each wavelength of the filter array 110. In this case, “multi-wavelength” refers to, for example, more wavelength ranges than 3-color wavelength ranges, which are RGB wavelength ranges, acquired by normal color cameras. The number of such wavelength ranges may be, for example, any number between 4 and about 100. The number of such wavelength ranges will be referred to as the “number of bands”. Depending on applications, the number of bands may exceed 100.

Data to be obtained is data of the hyperspectral image 220, and the data will be denoted by f. When the number of bands is N, f denotes data obtained by combining image data f₁ corresponding to the wavelength band W₁, image data f₂ corresponding to the wavelength band W₂, . . . , and image data f corresponding to the wavelength band W_{N}. In this case, as illustrated in FIG. 1A, suppose that the horizontal direction of the image is the x direction, and the vertical direction of the image is the y direction. When the number of pixels in the x direction for the image data to be obtained is n, and the number of pixels in the y direction for the image data to be obtained is m, the image data f₁, the image data f₂, . . . , and the image data f_{N} are each two-dimensional data having n×m pixels. Thus, the data f is three-dimensional data having n×m×N elements. This three-dimensional data will be referred to as “hyperspectral image data” or a “hyperspectral data cube”. In contrast, data g of the compressed image 120 acquired by the filter array 110 through encoding and multiplexing has n×m elements. The data g can be expressed by the following Eq. (1). The sign
g
   included in Eqs. (1) and (2) may be denoted by “g” in the description related to Eqs. (1) and (2).

$$g = Hf = H [ \begin{matrix}{f}_{1} \\ {f}_{2} \\ ⋮ \\ {f}_{N}\end{matrix} ] \qquad ( 1 )$$

In this case, f₁, f₂, . . . , f_{N} are each data having n×m elements. Thus, the vector on the right side is a one-dimensional vector having n×m×N rows and one column. The data g of the compressed image 120 is represented by being converted into a one-dimensional vector g having n×m rows and one column, and is calculated. A matrix H represents a conversion in which individual components f₁, f₂, . . . , f_{N} of a vector f are encoded and intensity-modulated using encoding information (hereinafter also referred to as “mask information”) that varies on a wavelength band basis, and are then added to each other. Thus, H denotes a matrix having n×m rows and n×m×N columns.

When the vector g and the matrix H are given, it seems that f can be calculated by solving an inverse problem of Eq. (1). However, the number of elements (n×m×N) of the data f to be obtained is greater than the number of elements (n×m) of the acquired data g, and thus this problem is an ill-posed problem, and the problem cannot be solved as is. Thus, the processing apparatus 200 uses the redundancy of the images included in the data f and uses a compressed-sensing method to obtain a solution. Specifically, the data f to be obtained is estimated by solving the following Eq. (2).

$${f}^{′} = {arg min}_{f} \{ {‖ g - Hf ‖}_{{l}_{2}} + τ Φ ( f ) \} \qquad ( 2 )$$

In this case, f denotes estimated data of the data f. The first term in the braces of the equation above represents a shift between an estimation result Hf and the acquired data g, which is a so-called residual term. In this case, the sum of squares is treated as the residual term; however, an absolute value, a root-sum-square value, or the like may be treated as the residual term. The second term in the braces is a regularization term or a stabilization term. Eq. (2) means to obtain f that minimizes the sum of the first term and the second term. The processing apparatus 200 can cause a solution to converge through a recursive iterative operation and can calculate the final solution f.

The first term in the braces of Eq. (2) refers to a calculation for obtaining the sum of squares of the differences between the acquired data g and Hf, which is obtained by converting f in the estimation process using the matrix H. The second term Φ(f) is a constraint for regularization of f and is a function that reflects sparse information regarding estimated data. This function provides an effect in that estimated data is smoothed or stabilized. The regularization term can be expressed using, for example, discrete cosine transformation (DCT), wavelet transform, Fourier transform, or total variation (TV) of f. For example, in a case where total variation is used, stabilized estimated data can be acquired in which the effects of noise of the data g, observation data, are suppressed. The sparsity of the target 70 in each space of the regularization term differs with the texture of the target 70. A regularization term having a regularization term space in which the texture of the target 70 becomes sparser may be selected. Alternatively, regularization terms may be included in calculation. τ is a weighting factor. The greater the weighting factor t, the greater the amount of reduction of redundant data, thereby increasing a compression rate. The smaller the weighting factor τ, the lower the convergence to the solution. The weighting factor t is set to an appropriate value with which f is converged to a certain degree and is not compressed too much.

Note that, in the configurations illustrated in FIGS. 1B and 1C, images encoded by the filter array 110 are acquired in bokeh states on the imaging surface of the image sensor 160. Thus, the hyperspectral image 220 can be generated by reflecting the bokch information in the above-described matrix H, the bokeh information being stored in advance. In this case, the bokeh information is expressed by a point spread function (PSF). The PSF is a function that defines the degree of spread of a point image to surrounding pixels. For example, in a case where a point image corresponding to one pixel on an image is spread to a region of k×k pixels around the pixel as a result of bokeh, the PSF can be defined as a group of factors, that is, a matrix indicating the effect on the luminance of each pixel in the region. The effect of bokch of an encoding pattern by the PSF is reflected in the matrix H, so that the hyperspectral image 220 can be generated. The filter array 110 may be disposed at any position; however, a position may be selected where the encoding pattern of the filter array 110 does not spread so much as to disappear.

Each pixel in a hyperspectral image generated using the method as described above includes light intensity or luminance value information of each of the wavelength bands included in a preset target wavelength range. As described above, each wavelength band is part of the target wavelength range. Each wavelength band may be a wavelength range having a certain width (for example, a wavelength range having a width of about 50 nm such as from 500 nm to 550 nm). In the present disclosure, not only a single wavelength range having a certain width but also a collection of wavelength ranges each having a width may also be similarly treated as a single “wavelength band”. In one example, a collection of a wavelength range having a width of 50 nm from 500 nm to 550 nm and a wavelength range having a width of 50 nm from 600 nm to 650 nm, that is, a combination of two wavelength ranges having 100 nm in total may also be treated as a single “wavelength band”. Each wavelength band may also have a small width on the order of, for example, about 1 nm to 20 nm. In one example, in a case where the target wavelength range is a range from 451 nm to 950 nm, and each wavelength band has a width of 5 nm, the target wavelength range contains 100 wavelength bands.

In a case where the luminance value of each pixel of each image of such many wavelength bands is to be calculated by performing the above-described calculation, generation of a hyperspectral image may take a long time due to the large amount of calculation.

The above-described imaging system may also be used in applications for capturing a video based on hyperspectral images. In cases where a person captures images of a target while holding an imaging apparatus in his/her hand, captures images of a target with an imaging apparatus mounted on a moving object, or captures images of a moving target while tracking the moving target, the relative position of the imaging apparatus and the target changes during image capturing. As a result, the position of the target in the captured video is shifted from frame to frame, resulting in an unstable video in which the target is blurred.

One frame may refer to one image or a group of images obtained by a single shot (exposure) in a video. One frame may be one compressed image. One frame may be images corresponding to the respective wavelength bands generated based on a single compressed image. One frame may be one image contained in images corresponding to the respective wavelength bands generated based on a single compressed image.

In an embodiment of the present disclosure, a method is used in which the relative motion between the imaging apparatus and the target is detected and a partial region including the target is extracted from the compressed image and reconstructed such that the effects of the relative motion are reduced. That is, the region of the compressed image other than the partial region including the target is not reconstructed. In the following, the summary of embodiments of the present disclosure will be described.

An imaging system according to an example of an embodiment of the present disclosure includes an imaging apparatus that acquires a compressed image in which information regarding light of four or more wavelength bands from a target is compressed, and a processing apparatus. The processing apparatus extracts a partial region including the region of the target from the compressed image so as to compensate for the relative motion between the target and the imaging apparatus, and generates spectral images corresponding to wavelength bands on the basis of data of the partial region of the compressed image.

As described above, the compressed image refers to an image in which information regarding the four or more wavelength bands is compressed as one monochrome image and a signal or data representing such an image. The compressed image may be output in the format of image data from the imaging apparatus, or a signal output from the image sensor included in the imaging apparatus may be simply output from the imaging apparatus as data representing the compressed image. The spectral images generated by the processing apparatus may correspond to the above-described four or more wavelength bands, some of the four or more wavelength bands, or any combination out of the four or more wavelength bands.

With the above-described configuration, the partial region including the target is extracted from the compressed image so as to compensate for the relative motion between the target and the imaging apparatus, and the above-described reconstruction calculation is performed on the partial region. This makes it possible to suppress the effects of the relative motion between the target and the imaging apparatus (for example, camera shake) and to generate one or more necessary spectral images in a short time with a small amount of calculation.

The imaging apparatus may repeatedly acquire such a compressed image. The processing apparatus may detect the relative motion between the target and the imaging apparatus on the basis of temporal changes of the compressed images and determine the partial region on the basis of the relative motion. For example, the processing apparatus may detect, from two consecutive frames of the compressed images, the relative motion between the target and the imaging apparatus and determine the partial region in accordance with the motion. Such an operation enables the partial region corresponding to the target to be appropriately extracted from the compressed image without using a sensor that detects the relative motion between the target and the imaging apparatus.

The imaging apparatus may include a filter array and an image sensor. The filter array includes filters whose spectral transmittances are different from each other. The image sensor detects light that has passed through the filter array, and outputs a signal representing the compressed image. The filter array may contain filters arranged in a two-dimensional plane as described with reference to FIGS. 2A to 2D, for example. Each filter may have, for example, transmittance peaks (or local maxima) in a predetermined target wavelength range. Compressed sensing using such a filter array can generate preferable spectral images.

The imaging system may further have a storage device that stores matrix data corresponding to the spectral transmittance of the filter array. The processing apparatus can be configured to generate spectral images on the basis of the portion of the matrix data corresponding to the partial region. For example, the calculation based on Eq. (2) described above can be applied to the partial region extracted from the compressed image to reconstruct spectral images with high accuracy.

The matrix data may be, for example, data representing the matrix H in Eq. (2) described above. The matrix data may be stored in the storage device, for example, in the form of a table. The table showing such a matrix may be referred to as a “reconstruction table” in the following description.

By performing a matching process based on a signal representing a first compressed image output at a first time from the image sensor and a signal representing a second compressed image output at a second time after the first time from the image sensor, the processing apparatus may extract a partial region from the second compressed image. The first compressed image may correspond to one frame of the video, for example, and the second compressed image may correspond to the next frame of the video, for example. In this manner, by matching two compressed images output at different times, the relative motion between the imaging apparatus and the target can be detected, and an appropriate partial region can be extracted from the second compressed image so as to compensate for the motion. By performing such an operation frame by frame, for example, the blurring of the target in the video caused by camera shake can be reduced.

The processing apparatus can be configured to generate spectral images from the data of the partial region on the basis of matrix data corresponding to the spectral transmittance of part of the filter array corresponding to the partial region of the second compressed image.

The imaging system may further include a sensor that detects the relative motion between the target and the imaging apparatus. The processing apparatus may determine the partial region on the basis of a signal output from the sensor. Such a configuration can further reduce the amount of processing and time since the relative motion between the target and the imaging apparatus can be detected without performing the matching process as described above.

The sensor may include at least one of an acceleration sensor and an angular rate sensor (for example, a gyro sensor). The sensor may include a vibration sensor. The processing apparatus may determine the motion vector of the imaging apparatus on the basis of the signal output from the sensor and may determine a partial region on the basis of the motion vector. In a case where the imaging system is mounted on a moving object such as a vehicle, the sensor may be an inertial measurement unit (IMU) mounted on the moving object.

The processing apparatus may cause the display to display the compressed image. Furthermore, the processing apparatus may cause the display to display a graphical user interface (GUI) for allowing the user to specify the target to be subjected to motion compensation in the compressed image. With such a configuration, the user can specify the target to be subjected to motion compensation while checking the compressed image. Thus, for example, in a case where objects are present in the compressed image, a specific object can be selected as a target, so that the case of operation is improved.

The processing apparatus may be configured to repeatedly acquire a signal representing a compressed image from the imaging apparatus, extract a partial region, and generate spectral images such that video data of each of the spectral images is generated. This allows, for example, videos of the respective wavelength bands to be generated in a short processing time.

A method according to another aspect of the present disclosure is a method performed by a computer and includes: acquiring, from an imaging apparatus that acquires a compressed image in which information regarding light of four or more wavelength bands from a target is compressed, a signal representing the compressed image; extracting a partial region including the target from the compressed image so as to compensate for a relative motion between the target and the imaging apparatus; and generating spectral images corresponding to wavelength bands, based on data of the partial region of the compressed image.

A computer program according to yet another aspect of the present disclosure is stored on a computer readable non-transitory recording medium. The computer program causes a computer to perform: acquiring, from an imaging apparatus that acquires a compressed image in which information regarding light of four or more wavelength bands from a target is compressed, a signal representing the compressed image; extracting a partial region including the target from the compressed image so as to compensate for a relative motion between the target and the imaging apparatus; and generating spectral images corresponding to wavelength bands, based on data of the partial region of the compressed image.

In the following, examples of embodiments of the present disclosure will be specifically described. Note that any one of the embodiments to be described below is intended to represent a general or specific example. Numerical values, shapes, constituent elements, arrangement positions and connection forms of the constituent elements, steps, and the order of steps are examples, and are not intended to limit the present disclosure. Among the constituent elements of the following embodiments, constituent elements that are not described in independent claims representing the most generic concept will be described as optional constituent elements. Each drawing is a schematic diagram and is not necessarily precisely illustrated. Furthermore, in each drawing, substantially the same or similar constituent elements are denoted by the same reference signs. Redundant description may be omitted or simplified.

### First Embodiment

A first embodiment of the present disclosure will be described as an example. An imaging system according to the present embodiment is a system that generates a video based on hyperspectral images. The imaging system includes an imaging apparatus and a processing apparatus that processes image data output from the imaging apparatus. As described above, the imaging apparatus performs compressed sensing imaging using a filter array in which filters having different spectral transmittances are two-dimensionally arranged, and acquires a compressed image in which information regarding four or more wavelength bands is compressed. Using reconstruction data (for example, matrix data) reflecting the spatial distribution of the spectral transmittance of the filter array, the processing apparatus reconstructs a hyperspectral image (namely, spectral images of the respective wavelength bands) from the compressed image. The processing apparatus detects the relative motion between the imaging apparatus and the target from compressed images of frames output consecutively from the imaging apparatus, and performs processing for stabilizing a video by compensating for the effects of motion. A target (namely a subject) in the compressed images may be, for example, a shape or region with feature points that can be recognized by image processing. The target may be a shape with a feature point located at the center of the image. Alternatively, in a case where the imaging system is configured to capture images while tracking a specific object, the target may be a shape or region corresponding to the object to be tracked over the images. In the following description, the region of the image other than the target is considered to be the background. The background may have feature points.

The processing apparatus performs matching between the compressed images of frames acquired through image capturing by the imaging apparatus to detect a motion vector between the frames resulting from the motion of the imaging apparatus. To reduce the effects of target misalignment over the images due to the motion vector, the processing apparatus extracts, from the compressed image of each frame, a partial region that includes the target and for which matching has been confirmed with another frame (for example, the immediately preceding frame). This reduces blurring of the image caused by the motion of the imaging apparatus. The processing apparatus performs the above-described reconstruction processing on the extracted partial region and generates a hyperspectral image of the extracted partial region.

In this manner, in order to reduce the effects of image blurring caused by the motion of the imaging apparatus, the processing apparatus according to the present embodiment extracts a partial region including the target from the compressed image and performs reconstruction processing on the extracted region. The processing apparatus does not perform the reconstruction processing on the region of the compressed image other than the partial region including the target. That is, the processing apparatus performs blur correction processing not on the image of each of many wavelength bands but on a single pre-reconstruction compressed image and further performs reconstruction processing only on the partial region cut out for blur correction. This processing can greatly reduce the amount of calculation for blur correction processing and hyperspectral image reconstruction processing and generate a hyperspectral image of the target in a short period of time.

### 1-1. Configuration

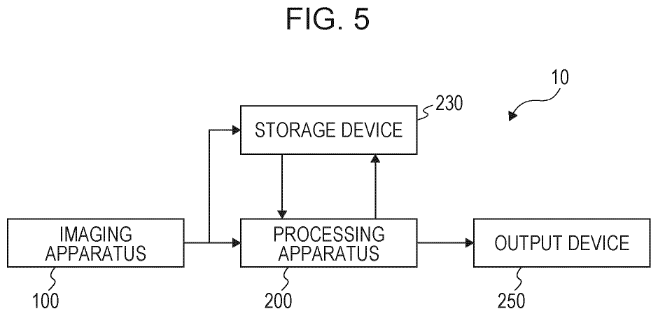

FIG. 5 is a block diagram illustrating the configuration of an imaging system 10 according to the present embodiment. This imaging system 10 generates a video based on hyperspectral images. Thus, the imaging system 10 can also be called a “hyperspectral video generation system”. The imaging system 10 includes an imaging apparatus 100, a processing apparatus 200, a storage device 230, and an output device 250.

The imaging apparatus 100 is a camera with substantially the same configuration as the imaging apparatus 100 illustrated in any of FIGS. 1A to 1D, for example. The imaging apparatus 100 may also be called a “compressive hyperspectral camera”. The imaging apparatus 100 includes the filter array 110, which functions as an encoding element, and the image sensor 160 as illustrated in, for example, FIG. 1A. The imaging apparatus 100 is capable of acquiring the aforementioned compressed image in a short time and with a single exposure. The compressed image is an image in which optical components of four or more wavelength bands are compressed as one monochrome image. By applying the arithmetic processing based on Eq. (2) described above to the compressed image, a hyperspectral image, namely, spectral images corresponding to wavelength bands, can be generated. In this manner, the compressed image contains information for generating the hyperspectral image. Thus, the compressed image may also be called a “compressed hyperspectral image”.

The image sensor 160 of the imaging apparatus 100 has photodetector cells that are arranged two-dimensionally. Each photodetector cell simultaneously receives light in which the components of the four or more wavelength bands are superposed, and outputs an electrical signal corresponding to the amount of light received. Based on the electrical signal output from the image sensor 160, a compressed image is constructed. The luminance value (also called a pixel value) of each pixel of the compressed image has at least two or more tones and may have, for example, 256 tones. In this manner, the information regarding the luminance of light detected by each photodetector cell of the image sensor 160 is reflected in the pixel value of the corresponding pixel in the compressed image. As a result, the compressed image retains information regarding the spatial distribution of the intensity of light detected by the image sensor 160.

To acquire a compressed image, the filter array 110 is used, which includes filters whose wavelength dependencies of transmittance are different from each other. The filters may be randomly arranged in a two-dimensional plane, for example. By acquiring a compressed image using the filter array 110 as described above, the compressed image is a luminance image having tones corresponding to the average transmittance obtained by averaging the luminous transmittances of the wavelength bands included in the target wavelength range.

The imaging apparatus 100 generates a compressed image at a predetermined frame rate (for example, 60 fps or 30 fps, etc.). The imaging apparatus 100 may be configured to generate and output a video based on these compressed images.

The processing apparatus 200 includes one or more processing circuits and one or more storage mediums (for example, memories). The one or more processing circuits may each be a processor such as a central processing unit (CPU) or a graphics processing unit (GPU), for example. The one or more processors execute a to-be-described operation by executing a computer program stored in a memory. The processing apparatus 200 acquires a video based on the compressed images output from the imaging apparatus 100, and generates a hyperspectral image of a region corresponding to a specific target on the basis of the compressed image of each frame of the video. Specifically, the processing apparatus 200 obtains, from the video based on the compressed images, motion vectors indicating the relative motion between an object within the field of view of the imaging apparatus 100 and the imaging apparatus 100 by performing matching between the compressed images of two or more temporally consecutive frames. The processing apparatus 200 selects a vector indicating the shake of the imaging apparatus 100 from the obtained motion vectors. The processing apparatus 200 cuts out, from the compressed image of each frame, the region of the target for which matching has been confirmed relative to a certain region of another frame so as to reduce the effects of the shake. Furthermore, the processing apparatus 200 refers to values corresponding to the cut-out region of the frame of interest in the reconstruction table stored in advance in the storage device 230 (for example, data indicating the matrix H in Eq. (2) described above) to perform reconstruction processing based on Eq. (2) described above on the cut-out compressed image. This allows the processing apparatus 200 to generate spectral images, namely a hyperspectral image, for a specific target frame by frame.

The storage device 230 is a device that includes one or more storage mediums, such as a semiconductor storage medium, a magnetic storage medium, or an optical storage medium, for example. The storage device 230 stores a reconstruction table based on the light transmission characteristics of the filter array 110 of the imaging apparatus 100. The reconstruction table contains data reflecting the two-dimensional distribution of the spectral transmittance of the filter array 110. For example, the reconstruction table may contain data indicating the transmittance of each wavelength band in the region of the filter array 110 corresponding to the position of each pixel of the image sensor 160. The storage device 230 also stores compressed images output from the imaging apparatus 100. The storage device 230 holds the compressed images of frames during the period when the processing apparatus 200 performs processing on the compressed images. The storage device 230 further stores various data generated by the processing apparatus 200 in the course of processing, such as data of a reconstructed hyperspectral image.

The output device 250 is a device that outputs compressed images acquired by the imaging apparatus 100, hyperspectral images generated by the processing apparatus 200 performing reconstruction processing, or both the compressed images and the hyperspectral images. The output device 250 may be, for example, a display, a printing machine, or a communications device. The display displays compressed images, hyperspectral images, or both compressed and hyperspectral images. The communications device transmits data of compressed images, data of generated hyperspectral images, or data of both compressed and hyperspectral images to an external device. The output device 250 may include a storage medium, such as a memory that stores data of generated compressed images, data of hyperspectral images, or data of generated compressed and hyperspectral images.

Note that, instead of outputting the video data including information regarding the compressed image of each frame, the imaging apparatus 100 may simply output the signal of each frame output from the image sensor 160. In that case, the processing apparatus 200 may be configured to generate compressed image data of each frame on the basis of the signal output from the image sensor 160 and reconstruct a hyperspectral image from the compressed image data.

### 1-2. Operation

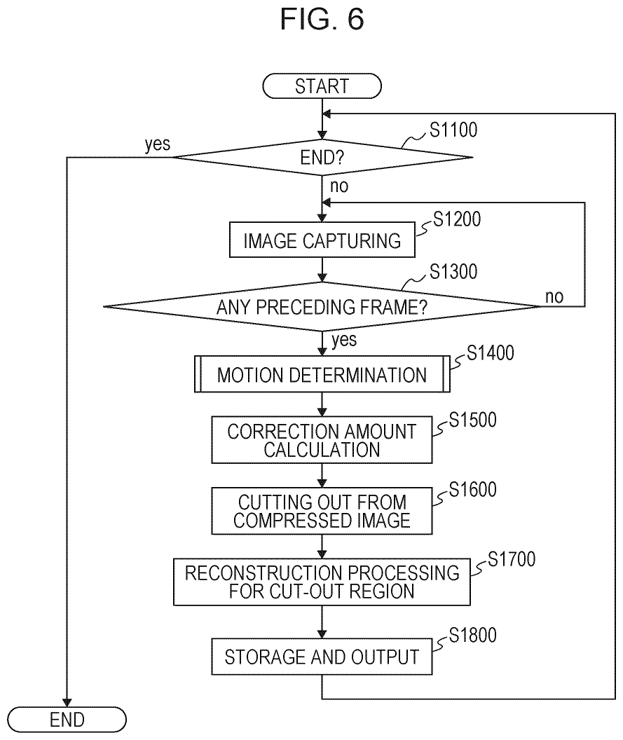

FIG. 6 is a flowchart illustrating the operation of the imaging system 10. The imaging system 10 starts operation in accordance with a start signal input from an input unit or communication unit that is not illustrated in the drawings. The imaging system 10 performs the operation from Steps S1100 to S1800 illustrated in FIG. 6. In the following, the operation in each Step will be described.

### Step S1100

The processing apparatus 200 determines whether or not an end signal that is an instruction to end the operation has been input. The end signal may be input from an input unit or communication unit that is not illustrated. In a case where the end signal has been input in Step S1100, the imaging system 10 ends the operation. In a case where the end signal has not been input in Step S1100, the process proceeds to Step S1200.

### Step S1200

The processing apparatus 200 sends, to the imaging apparatus 100, a signal for instructing the imaging apparatus 100 to perform image capturing. The imaging apparatus 100 captures an image of a scene including a target in response to the signal to generate a compressed image in which image information regarding wavelength bands is compressed. This compressed image corresponds to the picture of one frame of a video. The imaging apparatus 100 causes the storage device 230 to store the generated compressed image.

### Step S1300

The processing apparatus 200 determines whether or not the compressed image of the frame immediately preceding the frame of interest captured in Step S1200 is stored in the storage device 230. In a case where the compressed image of the immediately preceding frame is not stored in the storage device 230, the process returns to Step S1200. In a case where the compressed image of the immediately preceding frame is stored in the storage device 230, the process proceeds to Step S1400.

### Step S1400

The processing apparatus 200 performs matching between the compressed images of the frame of interest and the immediately preceding frame stored in the storage device 230 to extract a motion vector. Details of the operation in Step S1400 will be described below.

### Step S1500

The processing apparatus 200 calculates the amounts of correction of the image on the basis of the motion vector extracted in Step S1400. The amounts of correction indicate, for example, the amounts of shift of the image in horizontal and vertical directions to determine the reconstruction region of the image.

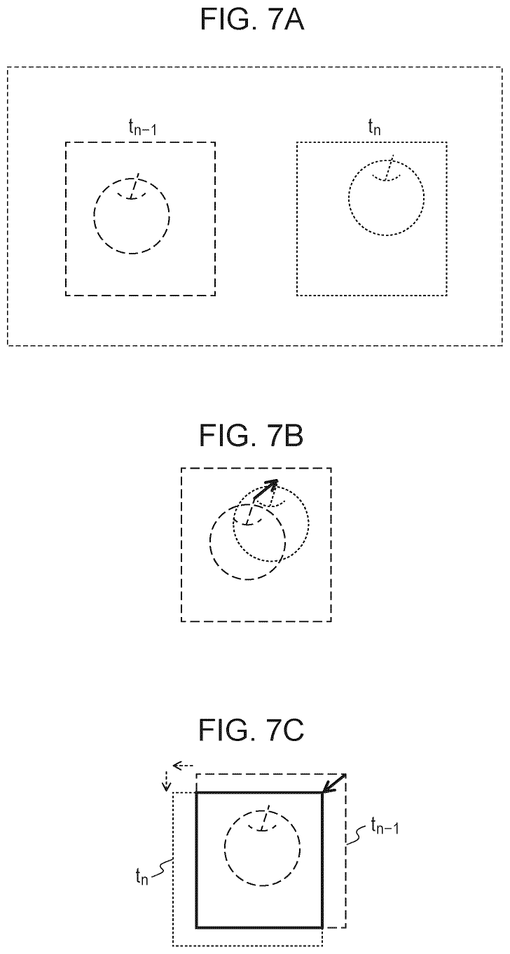

FIGS. 7A to 7C are schematic diagrams for describing the amounts of correction of the image and its calculation method. FIG. 7A schematically illustrates an example of the compressed images of two consecutive frames captured at a time tₙ₋₁ and a time tₙ. These two frames will be denoted by a frame tₙ₋₁ and a frame tₙ. The target in this example is the same stationary apple. The position of the target within the field of view of the imaging apparatus 100 is different between the frame tₙ₋₁ and the frame tₙ due to the motion of the imaging apparatus 100 (for example, camera shake) while the video is being captured.

FIG. 7B is a diagram illustrating a state where the image of the frame tₙ₋₁ and the image of the frame tₙ illustrated in FIG. 7A are superposed with each other. In FIG. 7B, the shift in the position of the target is indicated by an arrow. This arrow represents the motion vector caused by the relative motion of the imaging apparatus 100 with respect to the target.

FIG. 7C is a diagram illustrating a state where the image of the frame tₙ₋₁ and the image of the frame tₙ are superposed with each other such that the regions of the apple serving as the target overlap. In FIG. 7C, the dashed line indicates the frame tₙ₋₁, the dotted line indicates the frame tₙ, and the bold line indicates the overlapping region of the two frames.

The processing apparatus 200 calculates, as the amounts of correction, the horizontal and vertical components (indicated by dotted arrows in FIG. 7C) of the inverse vector of the motion vector illustrated in FIG. 7B. The processing apparatus 200 can superimpose the target in the image of the frame tₙ on the target in the image of the frame tₙ₋₁ by shifting the image of the frame tₙ horizontally and vertically by the respective amounts of correction. In other words, the processing apparatus 200 can superimpose the target in the image of the frame tₙ on the target in the image of the frame tₙ₋₁ by shifting the image of the frame tₙ in the opposite direction of the motion vector. This process can align, with the lower left corner of the image of the frame tₙ₋₁, the lower left corner of the region of the image of the frame tₙ that overlaps the image of the frame tₙ₋₁. This allows the compressed image of each frame to be corrected in accordance with the inter-frame motion vector, and the target can be made to remain stationary over the images.

### Step S1600

The processing apparatus 200 determines, on the basis of the amounts of correction obtained in Step S1500, a partial region including the target in the compressed image of the frame of interest, and extracts the partial region from the compressed image. For example, the processing apparatus 200 cuts out, from the compressed image, the region that overlaps the compressed image of the immediately preceding frame, as illustrated by the bold line in FIG. 7C. The extracted partial region may be part of the region that overlaps the compressed image of the immediately preceding frame.

### Step S1700

The processing apparatus 200 performs, on the basis of the data of the partial region cut out from the compressed image in Step S1600, processing for reconstructing spectral images corresponding to the wavelength bands, namely a hyperspectral image. The processing apparatus 200 performs reconstruction processing using part of the reconstruction table (namely matrix data) stored in the storage device 230 and corresponding to the partial region cut out in Step S1600. For example, in a case where a pixel region of the image of the frame tₙ illustrated in FIG. 7C that matches the image of the frame tₙ₋₁ is cut out as the partial region, the processing apparatus 200 performs reconstruction processing using information regarding the pixel values of the partial region and the part of the reconstruction table corresponding to the partial region. The reconstruction processing is substantially the same as that based on Eq. (2) described above.

In this manner, the processing apparatus 200 aligns the position of the target in the frame of interest with the position of the target in the immediately preceding frame, and performs reconstruction processing on the partial region that matches the immediately preceding frame. That is, the processing apparatus 200 does not perform reconstruction processing on the region of the frame of interest other than the partial region. This makes it possible to reduce the amount of calculation for reconstruction processing and to reduce the inter-frame motion of the target.

### Step S1800

The processing apparatus 200 outputs, to the output device 250, the hyperspectral image reconstructed in Step S1700 as the hyperspectral image of the frame of interest, and causes the storage device 230 to store the hyperspectral image. The output device 250 displays the hyperspectral image or sends the hyperspectral image to an external device, for example. After Step S1800, the process returns to Step S1100.

By repeating the operation from Steps S1100 to S1800, the processing apparatus 200 can generate a video based on the hyperspectral images. Through the above-described processing, a hyperspectral image video can be generated in which the motion of the target over the images (namely blur) caused by the relative motion between the imaging apparatus 100 and the target is reduced.

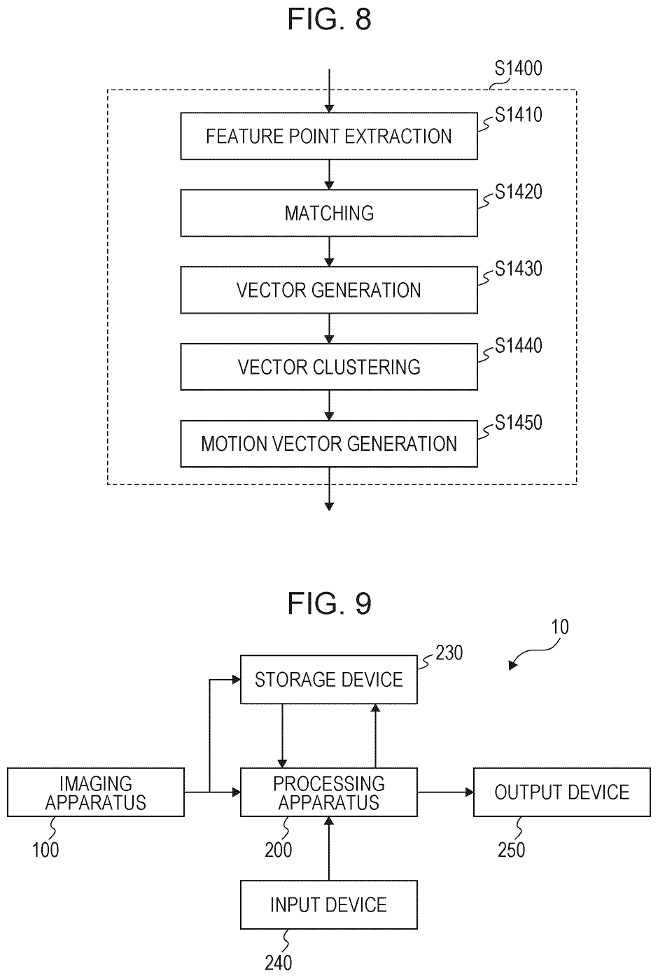

Next, a detailed example of the operation in Step S1400 will be described. FIG. 8 is a flowchart illustrating the detailed example of the operation in Step S1400. In the example illustrated in FIG. 8, Step S1400 includes Steps S1410 to S1450. In the following, the operation in each Step will be described.

### Step S1410

The processing apparatus 200 extracts feature points from the compressed image of the frame of interest acquired in Step S1200 and the compressed image of the immediately preceding frame stored in the storage device 230. The feature points may be, for example, points on edges or corners. The processing apparatus 200 can extract feature points from each compressed image by performing edge extraction processing using a spatial filter, such as a Sobel filter or Laplacian filter. Alternatively, the processing apparatus 200 may detect corners using a method, such as Harris corner detection or features from accelerated segment test (FAST), and extract points on the corners as feature points.

### Step S1420

Next, the processing apparatus 200 performs matching of the feature points extracted in Step S1410 between the image of the frame of interest and the image of the immediately preceding frame. Matching can be performed, for example, using a method in which feature points of the image of the frame of interest are extracted as patches and searching for the region with the highest similarity to the patches on the basis of an index value such as the sum of squared differences (SSD). Matching can be performed on feature points.

### Step S1430

For all feature points for which matching has been confirmed between the image of the frame of interest and the image of the immediately preceding frame, the processing apparatus 200 obtains vectors whose starting points are the positions of the feature points in the image of the immediately preceding frame and whose end points are the positions of the corresponding feature points in the image of the frame of interest.

### Step S1440

The processing apparatus 200 clusters the vectors obtained in Step S1430 in accordance with their direction and magnitude. That is, the processing apparatus 200 classifies the vectors into one or more clusters by clustering vectors that are close in direction and magnitude.

### Step S1450

Among the vectors clustered in step S1440, the processing apparatus 200 selects the cluster in which the starting points of the vectors are distributed over the widest range in the image, and treats the cluster as a cluster indicating blur caused by the motion of the imaging apparatus 100. The processing apparatus 200 generates, as a motion vector, the average of all vectors in this cluster in terms of direction and magnitude.

Using the above-described method, the processing apparatus 200 can determine the motion vector between two consecutive frames. Note that the method for matching between frames and the method for generating vectors are not limited to the above-described examples, and any method may be used.

### 1-3. Effects and Others

As described above, the imaging system 10 according to the present embodiment generates a video by continuously capturing compressed images. The processing apparatus 200 performs matching between temporally adjacent frames to determine a motion vector, and cuts out a partial region from the compressed image of each frame to reduce the effects of the motion vector. The processing apparatus 200 performs hyperspectral image reconstruction processing on the cut-out partial region. That is, the processing apparatus 200 does not perform the reconstruction processing on the region of the compressed image of interest other than the partial region. This makes it possible to generate a hyperspectral image video in which the blurring of the image of each frame caused by the relative motion between the imaging apparatus 100 and the target is reduced. In addition, since the partial images for blur correction are cut out from the compressed images rather than the images for many bands, the amount of calculation can be significantly reduced. Furthermore, since the reconstruction processing is performed not on the entire compressed image of each frame acquired through image capturing but on the partial regions of the compressed images cut out for blur correction, the amount of calculation for the reconstruction processing can also be reduced.

In the present embodiment, in Step S1450, the processing apparatus 200 selects the cluster in which the starting points of the vectors are distributed over the widest range in the image, and processes the cluster as a cluster indicating blur caused by the motion of the imaging apparatus 100. This is an operation performed to employ, as the “motion vector”, a common vector distributed over a wide region in the image. This type of operation is effective in reducing the effects of camera movement in a case where the imaging apparatus (namely a camera) is held and handled by hand, a case where the camera is mounted on a moving object, or a case where the camera is installed and used in a location subject to high vibration, such as beside a machine. In a case where the target is stationary, the entire image including the target will be included in the same cluster, and thus the above-described method can effectively remove the effects of camera movement from the image. In a case where the target is moving, the motion vectors of the target are concentrated in one place, and the motion vectors of the stationary objects in the vicinity of the camera are distributed over a wide region in the image because all the stationary objects have the same motion vector in accordance with the camera movement. Thus, by selecting the cluster whose motion vector is distributed over the widest range in the image, the motion of the target can be preserved and the blurring of the image caused by the camera movement can be corrected.

In contrast, in a case where the camera is fixed, and the target has motion, such as vibration or movement, the cluster in which the starting points of the vectors are concentrated in a certain region may be selected in Step S1450 from among the clustered vectors. Such a selection enables a moving target to be selected, and it is possible to generate a video that appears as if the target were stationary.

In a case where a moving target is tracked by a camera moving its field of view, the target is near the center of the field of view and its motion vector is relatively small while the motion vector of the background is relatively large. In such a case, in step S1450, a cluster in which the starting points of the vectors are concentrated in a certain region and the magnitudes of the vectors are smaller than the average magnitude of the vectors in the other clusters may be selected from among the clustered vectors. Such a selection allows the target to be selected that is tracked by the camera moving its field of view, and thus it is possible to generate a video that appears as if the target were stationary.

There may be a case where the camera is stationary but the background of the target is moving. For example, there may be a case where a road or a moving object, such as a conveyor belt, is present in the background or a case where a video in which the background is moving is projected by a projector or the like. In such a case, if the motion of the background is relatively constant and covers a wide region, a cluster in which the starting points of vectors are concentrated in a certain region may be selected in step S1450 from among the clustered vectors. Such a selection enables the cluster of the target to be selected even in a case where the target is moving, and it is possible to generate a video that appears as if the target were stationary.

Note that, in the first embodiment, matching is performed only between the images of two temporally adjacent frames, but matching may be performed between three or more temporally consecutive frames or between adjacent frames among the three or more temporally consecutive frames. In a case where the background changes, the feature point with the highest number of confirmed inter-frame matches may be extracted as the feature point indicating the target. In the correction processing, the motion vector for correction can be selected from the cluster including the vector constituted by the feature point with the highest number of confirmed inter-frame matches among the clusters of vectors formed by the feature points for which matching has been confirmed between the frame of interest and the immediately preceding frame. Such processing facilitates selection of the cluster of the target.

### First Modification of First Embodiment

Next, a modification of the first embodiment will be described.

The imaging system 10 according to the first embodiment generates a video by continuously capturing compressed images, and specifies a motion vector by performing matching between the compressed images of temporally consecutive frames. The imaging system 10 extracts a partial region including the target from the compressed image of each frame on the basis of the motion vector as to correct the relative motion between the imaging apparatus 100 and the target and performs reconstruction processing on the extracted partial region. That is, the processing apparatus 200 does not perform the reconstruction processing on the region of the compressed image other than the partial region. This makes it possible to reduce the amount of calculation needed to perform hyperspectral image reconstruction processing and suppress the effects of blur caused by the relative motion between the imaging apparatus 100 and the target.

In contrast, in the present modification, the user or an external device (for example, a computer system, such as a determination system) specifies a target in the compressed image of each frame. The imaging system performs inter-frame matching for the feature points included in the region of the target specified in the compressed image and generates a video in which the misalignment of the target has been corrected.

FIG. 9 is a block diagram illustrating the configuration of the imaging system 10 according to the present modification. The imaging system 10 further includes an input device 240 in addition to the constituent elements illustrated in FIG. 5. The output device 250 according to the present modification has a display for displaying the compressed images generated by the imaging apparatus 100 and the hyperspectral images generated by the processing apparatus 200. The processing apparatus 200 according to the present modification causes the display to display a compressed image, and causes the display to display a graphical user interface for allowing the user to specify, in the compressed image, a target to be subjected to motion compensation.

The input device 240 may include, for example, a pointing device. The user can use the pointing device to specify the position of a specific target while viewing the compressed image displayed on the display of the output device 250. Alternatively, the input device 240 may include a keyboard or a voice input device. In that case, the user can use the keyboard or voice input device to select the region corresponding to the specific target from the compressed image displayed on the display of the output device 250. The processing apparatus 200 may divide the displayed compressed image into regions and cause the output device 250 to display the compressed image so that the user can select the region corresponding to the target from these regions. The input device 240 may include a communication device that receives a signal for specifying the target from an external system of the imaging system 10. Even in that case, the target may be specified using the method for specifying the position or region corresponding to the target in the compressed image. The target may also be specified using a method for transmitting data such as an image indicating a template of the target to be searched for in the compressed image.

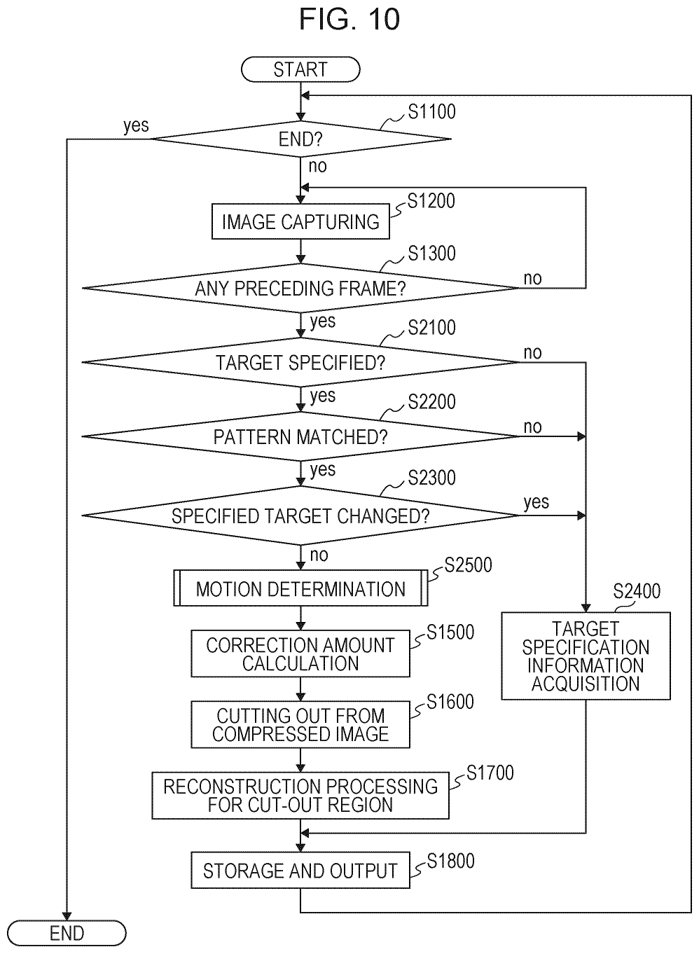

FIG. 10 is a flowchart illustrating the operation of the imaging system 10 according to the present modification. This flowchart is a flowchart obtained by adding Steps S2100 to S2400 after Step S1300 and replacing Step S1400 with Step S2500 in the flowchart illustrated in FIG. 6. In the following, different points from the operation illustrated in FIG. 6 will be described. As an example, the following describes an operation performed in a case where the user checks the compressed image displayed on the display included in the output device 250 and specifies a target using the pointing device included in the input device 240.

### Step S2100

In a case where it is determined in Step S1300 that the preceding frame has been recorded, the processing apparatus 200 determines whether or not specified information regarding the target is already present. The specified information regarding the target may be, for example, information indicating one or more feature points extracted from a region specified using the input device 240 on the compressed image displayed on the output device 250 at the time of or before acquisition of the compressed image of the frame of interest. The processing apparatus 200 may be configured to extract one or more feature points in the region including the position corresponding to the specific target or the region including the specific target when the user specifies the position or region corresponding to the specific target, and to cause the memory to store information indicating the one or more feature points as the specified information regarding the target. The one or more extracted feature points may also be referred to as the “pattern of the target” in the following. In a case where the specified information regarding the target is already present in Step S2100, the process proceeds to Step S2200. In a case where the specified information regarding the target is absent, the process proceeds to Step S2400.

### Step S2200

The processing apparatus 200 searches for the pattern of the target on the compressed image of the frame of interest and determines whether or not there is a region that matches the pattern. In a case where there is a region that matches the pattern in the image of the frame of interest, the processing apparatus 200 may display, on the compressed image of the frame of interest displayed on the output device 250, the region of the target for which matching has been confirmed. For example, the region of the target may be displayed with a rectangular frame or a frame of another shape surrounding the region of the target, by filling the region of the target, or the like. The region of the target for which matching has been confirmed may also be displayed using a sign or text. After the display, the process proceeds to Step S2300. In a case where there is not a region that matches the pattern of the target in the image of the frame of interest, the process proceeds Step S2400.

### Step S2300

The processing apparatus 200 determines the presence or absence of an input for changing the specified information regarding the target. In the present embodiment, the user can change the specified target while viewing the displayed compressed image during video capturing. The presence or absence of an input for changing the specified information regarding the target may be determined by whether or not an input instruction for changing the target has been input from the input device 240. For example, the presence or absence of an input for changing the specified information regarding the target may be determined whether or not an input for specifying a region or a position other than the region of the target displayed on the output device 250 has been input from the input device 240. In a case where an input for changing the specified information regarding the target is present, the process proceeds to Step S2400. In a case where an input for changing the specified information regarding the target is absent, the process proceeds to Step S2500.

### Step S2400

The processing apparatus 200 acquires information regarding the position specified by the pointing device of the input device 240 on the compressed image displayed on the output device 250. For example, the processing apparatus 200 treats, in the closed space enclosed by edges in the image of the frame of interest, a region including the position input from the input device 240 on the image as the region of a new target and generates information indicating the feature points (namely the pattern of the target) included in the region as specified information regarding the new target. After Step S2400, the process proceeds to Step S1800.

### Step S2500

The processing apparatus 200 searches the image of the immediately preceding frame for feature points corresponding to the feature points of the target in the image of the frame of interest for which pattern matching has been confirmed in Step S2200. The processing apparatus 200 further generates a motion vector from vectors whose starting points are the positions of the feature points in the image of the immediately preceding frame and whose end points are the positions of the feature points in the image of the frame of interest.

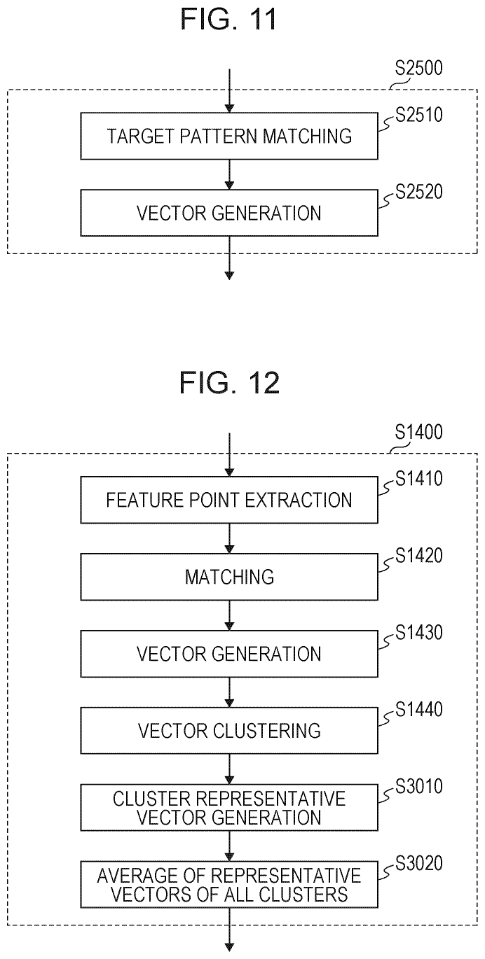

FIG. 11 is a flowchart illustrating a more detailed example of the operation in Step S2500. In this example, Step S2500 includes Steps S2510 and S2520. In the following, the operation in each Step will be described.

### Step S2510

The processing apparatus 200 performs matching between the image of the immediately preceding frame and the pattern of the target acquired in Step S2100, and specifies feature points that match the pattern of interest.

### Step S2520

The processing apparatus 200 generates a motion vector from vectors whose starting points are the positions of the feature points indicating the pattern of the target in the image of the immediately preceding frame for which matching has been confirmed in Step S2510 and whose end points are the positions of the feature points indicating the pattern of the target in the image of the frame of interest for which matching has been confirmed in Step S2200.

After Step S2500, similarly to as in the example illustrated in FIG. 6, the operation in Steps S1500 to S1800 is performed. After Step S1800, the process returns to Step S1100.

The above-described processing makes it possible to generate a hyperspectral image of the region including the specified target even in a case where the specified target is changed during image capturing.

As described above, the processing apparatus 200 according to the present modification performs matching between the compressed images of temporally consecutive frames on the basis of the pattern including the feature points of the specified target to generate a motion vector indicating the misalignment of the target between the frames. A partial region including the target is extracted from the compressed image of the frame of interest so as to correct blur on the basis of this motion vector, and reconstruction processing is performed on the partial region. That is, the processing apparatus 200 does not perform the reconstruction processing on the region of the compressed image of interest other than the partial region. This allows the position of the target in the video to stabilize. The amount of calculation can be reduced by treating the partial region as a reconstruction processing target. Furthermore, even in a case where the target for image capturing is changed and specified, a hyperspectral image can be generated for the specified target. In the frame in which the target has been changed, the processing apparatus 200 dose not perform correction processing to match the position of the pre-change target but performs blur correction processing in the subsequent frames with respect to the position of the newly specified target. In this manner, the processing apparatus 200 can easily perform target switching in response to the user changing the specified target. Even in a case where it is difficult to perform feature point matching over the entire image and cluster motion vectors of feature points to select a vector to be subjected to correction as in the first embodiment (for example, a case where there are many moving objects in the background and many various clusters of vectors are present within the field of view), the position of the target in the video can be stabilized. For example, in a case where there are many moving objects in the field of view or a case where there are many changing or moving shapes in the field of view, such as projection, many clusters of motion vectors will be generated, making it difficult to select a motion vector to be used for correction. Even in such a case, it is possible to select the target in the present modification, and thus the position of the target in the video can be stabilized.

Note that, in the present modification, the case is assumed in which the user checks the compressed image displayed on the display of the output device 250 and specifies a target using the pointing device of the input device 240; however, an external system may specify a target. In that case, in Step S2400, the output device 250 may be configured to output the compressed image of the frame of interest to an external system. The external system may be configured to transmit, to the input device 240, position information regarding the feature points of the new target and information indicating the matching pattern. In that case, the external system may include a recognition apparatus that determines a target from the compressed image.

### Second Modification of First Embodiment

In the first embodiment, the processing apparatus 200 determines a motion vector by performing matching between the compressed images of temporally consecutive frames, and extracts a partial region corresponding to a target from the compressed image of each frame so as to correct the motion. In the first modification of the first embodiment, the user or the external system specifies a target within the field of view, and the processing apparatus 200 performs frame-by-frame pattern matching for the specified target to determine its motion vector and extracts a partial region corresponding to the target from the compressed image of each frame so as to correct the motion.

In contrast, in the present modification, the processing apparatus 200 performs feature point matching between temporally consecutive frames, extracts a common component contained in motion vectors, and performs correction based on the common component.

The configuration of the imaging system 10 according to the present modification is substantially the same as that of the first embodiment illustrated in FIG. 5, and thus description will be omitted.

FIG. 12 is a flowchart illustrating part of the operation of the processing apparatus 200 according to the present modification. The operation in this modification is substantially the same as that in the first embodiment illustrated in FIG. 6; however, details of the operation in Step S1400 are different from those in the first embodiment. FIG. 12 illustrates details of the operation in Step S1400 according to the present modification. The flowchart illustrated in FIG. 12 is a flowchart obtained by replacing Step S1450 in the flowchart illustrated in FIG. 8 with Steps S3010 and S3020. The operation in Steps S1410 to S1440 is the same as that illustrated in FIG. 12. In the following, the operation in Steps S3010 and S3020 will be described.

### Step S3010

For each cluster obtained by clustering the vectors connecting the positions of the individual feature points in the image of the immediately preceding frame generated in step S1440 and the positions of the corresponding feature points in the image of the frame of interest, the processing apparatus 200 generates the average vector of all vectors in the cluster as the representative vector of the cluster. Note that instead of the average vector, a representative vector may be generated or selected on the basis of the distribution state of the vectors, or other methods may be used to generate a representative vector.

### Step S3020

The processing apparatus 200 generates a vector by averaging all of the representative vectors for the respective clusters generated in Step S3010. The processing apparatus 200 considers the average vector of the generated representative vectors of all clusters generated to be the common component of the relative motion between the imaging apparatus 100 and the subject in the field of view from the immediately preceding frame to the frame of interest, and processes the common component as a motion vector for correction processing.

As described above, in the present modification, it is possible to suppress the effects of the overall motion between frames while the movement of the moving subject remains intact by using, as the motion vector for correction processing, the common component of the motion vectors of several subjects including the specific target in the field of view.

### Third Modification of First Embodiment

In the second modification of the first embodiment, a representative vector is generated for each cluster obtained by clustering vectors connecting the positions of feature points in the image of the immediately preceding frame and the positions of feature points in the image of the frame of interest, and the average of the representative vectors is processed as a motion vector representing the motion of the entire image.

In contrast, the processing apparatus 200 according to the present modification generates a motion vector representing the motion of the entire image by using vectors generated based on feature points for which correspondence has been confirmed between the immediately preceding frame and the frame of interest, without clustering the vectors. In the following, different points from the second modification will be described.

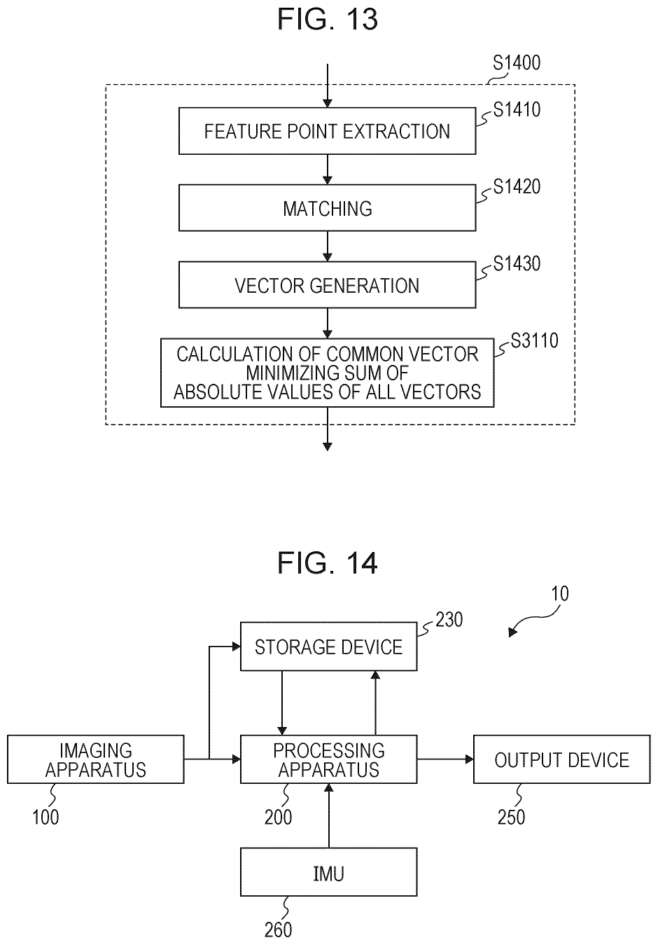

FIG. 13 is a flowchart illustrating part of the operation of the processing apparatus 200 according to the present modification. Although the operation illustrated in FIG. 6 is performed even in this modification, details of the operation in Step S1400 are different from those of the operations illustrated in FIGS. 8 and 12. In the present modification, after Step S1430, the following processing in Step S3110 will be performed.

### Step S3110

The processing apparatus 200 generates a motion vector indicating the common motion component of the video using all of the vectors that are obtained in Step S1430 and generated based on the feature points for which correspondence has been confirmed between the immediately preceding frame and the frame of interest. The common motion component may be generated by, for example, obtaining a motion vector that minimizes the sum of the absolute values of all of the vectors in a case where the compressed image illustrated in FIG. 7C is corrected.

Note that, regarding the magnitudes of the vectors, the vectors obtained in Step S1430 may be simply used in Step S3110; however, each vector may be weighted depending on the starting point of the vector to perform the operation in Step S3110. For example, the processing in Step S3110 may be performed for vectors that are weighted such that the weight is set large at the image center and decreases as the distance from the image center increases. Such weighting facilitates suppression of the effects of the motion of a subject (for example, a reconstruction target) in the center of the image. For example, the processing in Step S3110 may be performed for vectors that are weighted such that the weight is set small at the image center and increases as the distance from the image center increases. Such weighting facilitates suppression of the effects of the motion of a subject (for example, the background) in the periphery portion of the image.

In this manner, the processing apparatus 200 according to the third modification generates a motion vector for correcting the motion of the entire image by using vectors generated based on feature points for which correspondence has been confirmed between the immediately preceding frame and the frame of interest, without clustering the vectors. By weighting, when calculating the vector for correction, the vectors generated based on the feature points for which correspondence has been confirmed between the immediately preceding frame and the frame of interest depending on the positions of the vectors, it is possible to vary the level of motion suppression. This allows the target near the image center in the video or the background to stabilize.

### SECOND EMBODIMENT

Next, a second embodiment of the present disclosure will be described.

In the first embodiment and the first to third modifications thereof, matching is performed between the images of temporally consecutive frames captured by the imaging apparatus 100 in order to detect the relative motion between the target (or another subject within the field of view) and the imaging apparatus. In contrast, one or more sensors for detecting the motion of the imaging apparatus 100 are used in the present embodiment. The one or more sensors may include, for example, at least one of an acceleration sensor and an angular rate sensor. The one or more sensors may include, for example, an inertial measurement unit (IMU). The IMU may be a package of an acceleration sensor, a rotational angular acceleration sensor, a gyro sensor, a geomagnetic sensor, an atmospheric pressure sensor, and a humidity sensor, for example. In the following, a case where a sensor is an IMU will be described as an example.

FIG. 14 is a block diagram illustrating the configuration of the imaging system 10 according to the present embodiment. The configuration of the imaging system 10 is substantially the same as that of the first embodiment illustrated in FIG. 5 except that an IMU 260 has been added.

The IMU 260 measures acceleration and angular acceleration in the 3-axis directions (x, y, z axes) of the imaging system 10, and outputs these six measurement values.

The processing apparatus 200 acquires, frame by frame, a compressed image captured by the imaging apparatus 100. The processing apparatus 200 also acquires information regarding acceleration and angular acceleration involved in the movement of the system 10, the information being measured by the IMU 260. For each frame, the processing apparatus 200 calculates the distance traveled and rotation angle in the 3-axis directions by integrating, two times, the acceleration and angular acceleration in the 3-axis directions measured in the period from when the immediately preceding frame was captured to when the frame of interest was captured. This makes it possible to obtain changes in the movement and orientation of the imaging apparatus 100 and determine a motion vector for image correction.

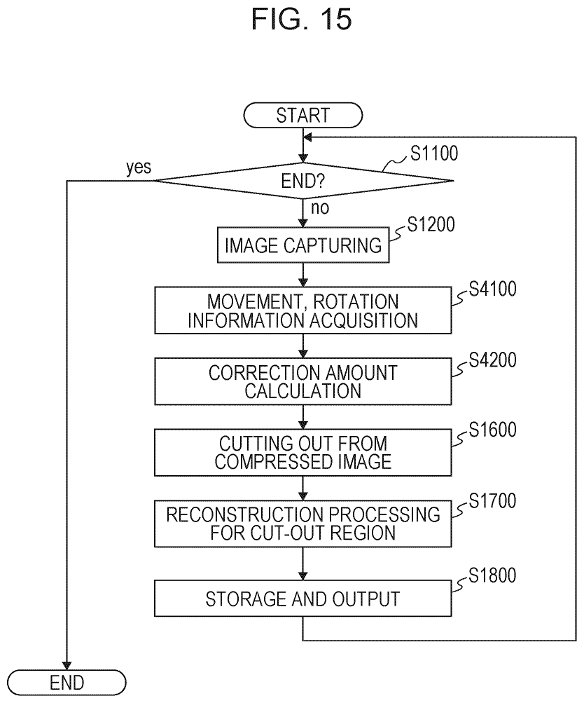

FIG. 15 is a flowchart illustrating the operation of the imaging system 10 according to the present embodiment. The flowchart illustrated in FIG. 15 is a flowchart obtained by replacing Steps S1300 and S1400 in the flowchart illustrated in FIG. 6 with Step S4100 and replacing Step S1500 with Step S4200. In the following, the operation in Steps S4100 and S4200 will be described.

### Step S4100

The processing apparatus 200 acquires, from the IMU 260, the information regarding acceleration and angular acceleration in the 3-axis directions during the frame interval of the imaging apparatus 100. For example, in a case where the frame rate is 60 Hz and the frame interval is 16 ms, the processing apparatus 200 acquires information regarding acceleration and angular acceleration in the 3-axis directions during the 16 ms period between the immediately preceding frame and the current frame.

### Step S4200

The processing apparatus 200 generates, from the information regarding acceleration and angular acceleration in the 3-axis directions acquired in Step S4100, a correction vector to be used in correction processing. For example, in a case where the frame interval is 16 ms, the processing apparatus 200 calculates the amounts of movement in the 3-axis directions by integrating the accelerations in the 3-axis directions during the 16 ms period two times. Furthermore, the rotation angles in the 3-axis directions are calculated by integrating the angular accelerations in the 3-axis directions during the 16 ms period two times. The processing apparatus 200 converts the amounts of movement and rotation angles in the 3-axis directions into a vector whose starting point is the origin of the coordinate system of the IMU 260. The vector in the opposite direction of this vector is projected onto the plane containing the light receiving surface of the image sensor 160 in this coordinate system, and the projected vector can be used as a correction vector. This correction vector is used in processing for cutting out a partial image from the compressed image in the subsequent Step S1600 (refer to FIG. 7C). The process in and after Step S1600 is the same as that illustrated in FIG. 6.

As described above, according to the present embodiment, the imaging system 10 captures a video by continuously capturing compressed images. Using information regarding the accelerations and angular accelerations measured in the 3-axis directions during image capturing, the imaging system 10 further obtains, as a motion vector, the shift of the image caused by the movement of the imaging apparatus 100 in the period from the immediately preceding frame to the frame of interest. A partial region including the target is cut out from the compressed image of each frame to correct the movement, and reconstruction processing is performed on the cut-out region. That is, the imaging system 10 does not perform reconstruction processing on the region of the compressed image other than the partial region. This makes it possible to generate a hyperspectral image video in which the blurring of the image of each frame caused by the movement or shake of the imaging apparatus 100. In addition, the amount of calculation can be significantly reduced because the partial images for blur correction are cut out from compressed images rather than from the images for many bands. Furthermore, since the reconstruction processing is performed not on the entire compressed image of each frame acquired through image capturing but on a partial region of the compressed image cut out for blur correction, the amount of calculation for the reconstruction processing can also be reduced.

Note that the imaging system 10 may include a sensor other than the IMU 260, such as a gyro sensor. By using a gyro sensor, information regarding the movement or vibration and the rotation of the imaging system 10 can be acquired. Alternatively, the imaging system 10 may include, in addition to the imaging apparatus 100, another imaging apparatus (namely a camera) that has a field of view that includes the full field of view of the imaging apparatus 100. Information regarding the movement or vibration and the rotation of the imaging system 10 may be acquired using images captured by the other imaging apparatus. The other imaging apparatus may acquire information regarding the movement or vibration and the rotation of the imaging system 10 by performing inter-frame matching or using other methods. Alternatively, the motion of the imaging system 10 may be sensed by, for example, a fixed camera separate from the imaging system 10, and the imaging system 10 may acquire motion information from the fixed sensor through communication.

As described above, in the first embodiment, motion vectors are generated by performing matching between the frames of the compressed images. In the second embodiment, motion vectors are generated on the basis of information acquired by a sensor, such as an IMU or another camera other than the imaging apparatus 100. The configurations of the first and second embodiments may be combined. For example, the motion of the imaging apparatus 100 may be detected using a sensor such as an IMU or a gyro sensor, and the search range in inter-frame matching of compressed images may be limited in accordance with the amount and direction of the detected motion. Such an operation can further reduce the amount of calculation.

In each of the above-described embodiments and the modifications, the processing apparatus 200 of the imaging system 10 outputs a hyperspectral image video but does not have to output a hyperspectral image video. For example, the processing apparatus 200 may select one or more spectral images among the spectral images of the wavelength bands constituting a hyperspectral image and output a video based on the selected spectral images.

In each of the above-described embodiments and the modifications, the imaging system 10 may be configured as a single apparatus. The imaging system 10 may be mounted on a vehicle, a drone, a robot, or other mobile vehicles. The imaging apparatus 100 and the processing apparatus 200 in the imaging system 10 may be installed at locations apart from each other. In the following, an example of such a configuration will be described.

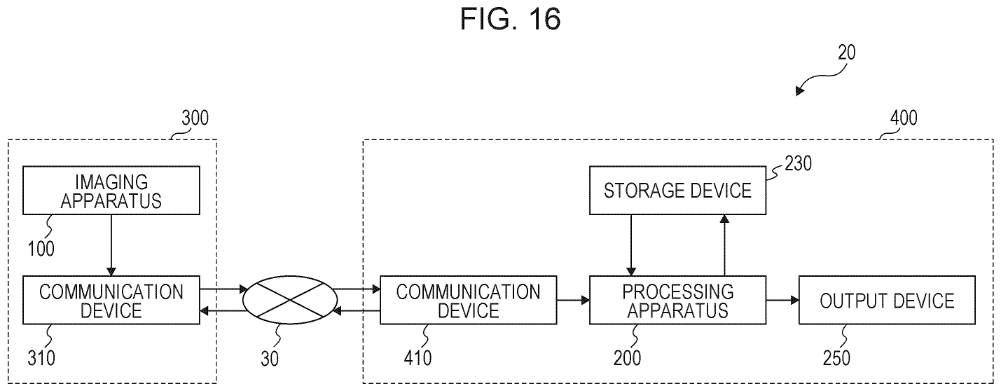

FIG. 16 is a diagram illustrating an example of the configuration of an imaging system 20 in which the imaging apparatus 100 and the processing apparatus 200 are installed at locations apart from each other. The imaging system 20 includes a first apparatus 300 that captures a video of a target and a second apparatus 400 that performs signal processing. The first apparatus 300 and the second apparatus 400 are connected to each other through a network 30, such as the Internet, such that communication is possible. The network 30 may be a network using either of wireless and wired communication methods.

The first apparatus 300 includes the imaging apparatus 100 and a communication device 310. The second apparatus 400 includes a communication device 410, the processing apparatus 200, the storage device 230, and the output device 250. The imaging apparatus 100, the processing apparatus 200, the storage device 230, and the output device 250 have substantially the same functions as their corresponding apparatuses/devices illustrated in FIG. 5. The first apparatus 300 may further include a sensor that measures the motion of the imaging apparatus 100, such as an IMU. The second apparatus 400 may further include the input device 240 illustrated in FIG. 9.

The communication device 310 and the communication device 410 perform data communication between the first apparatus 300 and the second apparatus 400. The communication device 310 transmits compressed images acquired by the imaging apparatus 100. The communication device 410 receives the compressed images. The processing apparatus 200 performs substantially the same processing as in any of the above-described embodiments and the modifications on the compressed images received by the communication device 410. This makes it possible to generate a spectral image of each wavelength band.

In each of the above-described embodiments and the modifications, the processing apparatus 200 is a single device, but the functions of the processing apparatus 200 may be distributed among devices. Such devices may be located at locations apart from each other and may be connected via a network such that communication is possible. Similarly, the storage device 230 may be a single device or a collection of separate devices.

### Other 1

The present disclosure is not limited to the above-described embodiments. Examples obtained by adding various changes conceived by one skilled in the art to each embodiment, examples obtained by adding various changes conceived by one skilled in the art to each modification, forms constructed by combining constituent elements of different embodiments, forms constructed by combining constituent elements of different modifications, and forms constructed by combining constituent elements of any embodiment and constituent elements of any modification are also included in the scope of the present disclosure as long as these examples and forms do not depart from the gist of the present disclosure.

### Other 2

In the following, the way in which the processing apparatus can reduce the amount of calculation will be described using the imaging system 10 described in the first modification of the first embodiment. The processing performed in the present modification and described below may be performed in the imaging systems described in the first embodiment, the second embodiment, and the modifications of the first embodiment other than the first modification.

The present modification may be as follows.

An imaging system includes
a filter array including filters having different transmittance characteristics from each other with respect to wavelengths from a first wavelength to a second wavelength, the first wavelength being lower than the second wavelength,
an image sensor, and
a processor,
the processor causes the image sensor to capture an image of a target at a first time, the image sensor thus outputs a first image, the first image is based on first light from the filter array, the image sensor receives the first light,
   the first light is based on second light incident on the filter array from the target,
the processor determines a first region included in the first image,
   the first image includes the first region and a second region,
   the first region includes the target, the first region includes first pixels,
   the second region does not include the target, the second region includes second pixels,
   the first region does not include a region included in the second region,
   the second region does not include a region included in the first region,
the processor calculates, on the basis of the first image and a matrix H, first pixel values corresponding to third pixels,
the processor does not calculate, on the basis of the first image and the matrix H, second pixel values corresponding to fourth pixels,
   the third pixels and the fourth pixels are included in an image I(1k),
   the third pixels correspond to the first pixels, the fourth pixels correspond to the second pixels,
   the image I(1k) corresponds to a k-th wavelength range Wk,
   1≤ k≤N, k is an integer, N is an integer, the lowest wavelength included in the k-th wavelength range Wk is greater than or equal to the first wavelength, the highest wavelength included in the k-th wavelength range Wk is less than or equal to the second wavelength,
the processor causes the image sensor to capture an image of the target at a second time, the image sensor thus outputs a second image, the second image is based on third light from the filter array, the image sensor receives the third light,
   the third light is based on fourth light incident on the filter array from the target,
   the second time is later than the first time,
the processor determines a third region included in the second image,
   the second image includes the third region and a fourth region,
   the third region includes the target, the third region includes fifth pixels,
   the fourth region does not include the target, the fourth region includes sixth pixels,
   the fifth region does not include a region included in the sixth region,
   the sixth region does not include a region included in the fifth region,
the processor calculates, on the basis of the second image and the matrix H, third pixel values corresponding to seventh pixels,
the processor does not calculate, on the basis of the second image and the matrix H, fourth pixel values corresponding to eighth pixels,
   the seventh pixels and the eighth pixels are included in an image (2k),
   the seventh pixels correspond to the fifth pixels, the eighth pixels correspond to the sixth pixels, and
   the image I(2k) corresponds to the k-th wavelength range Wk.

The processor may determine the first region on the basis of information specified by the user.

The processor may determine the third region on the basis of one or more feature points included in the second image and one or more feature points included in the first region.

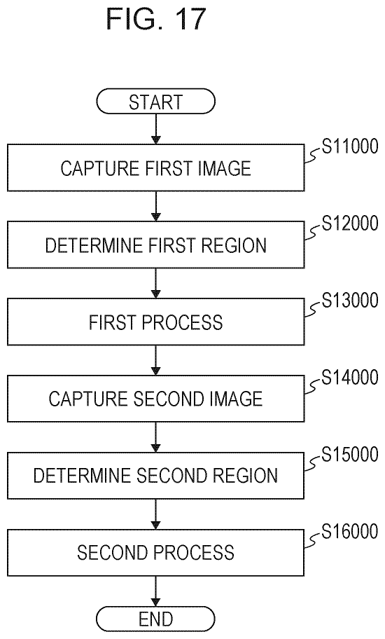

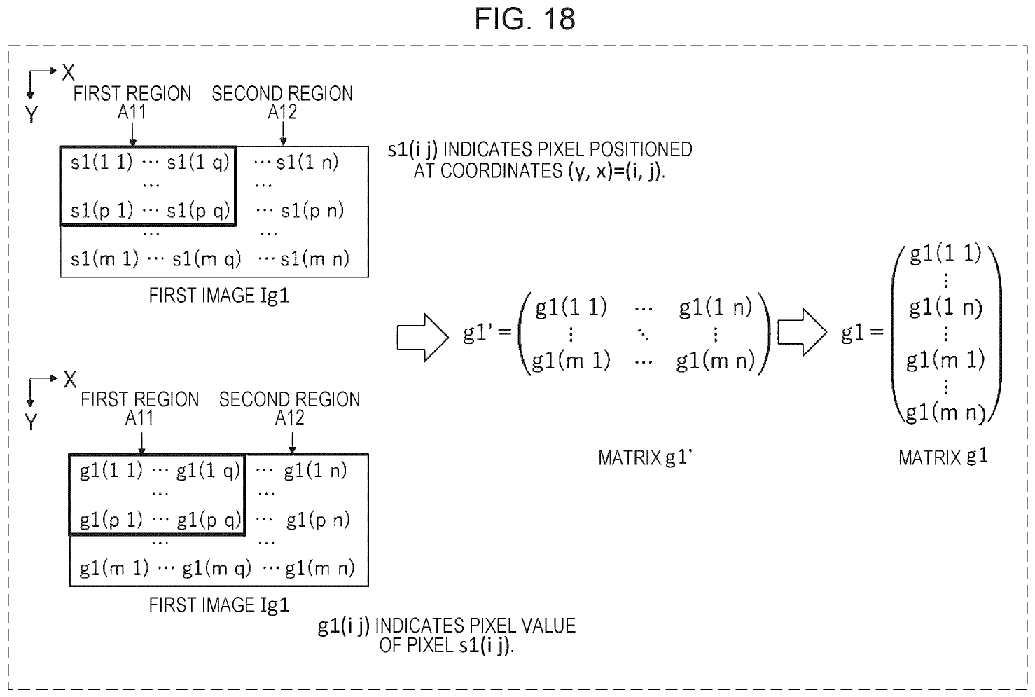

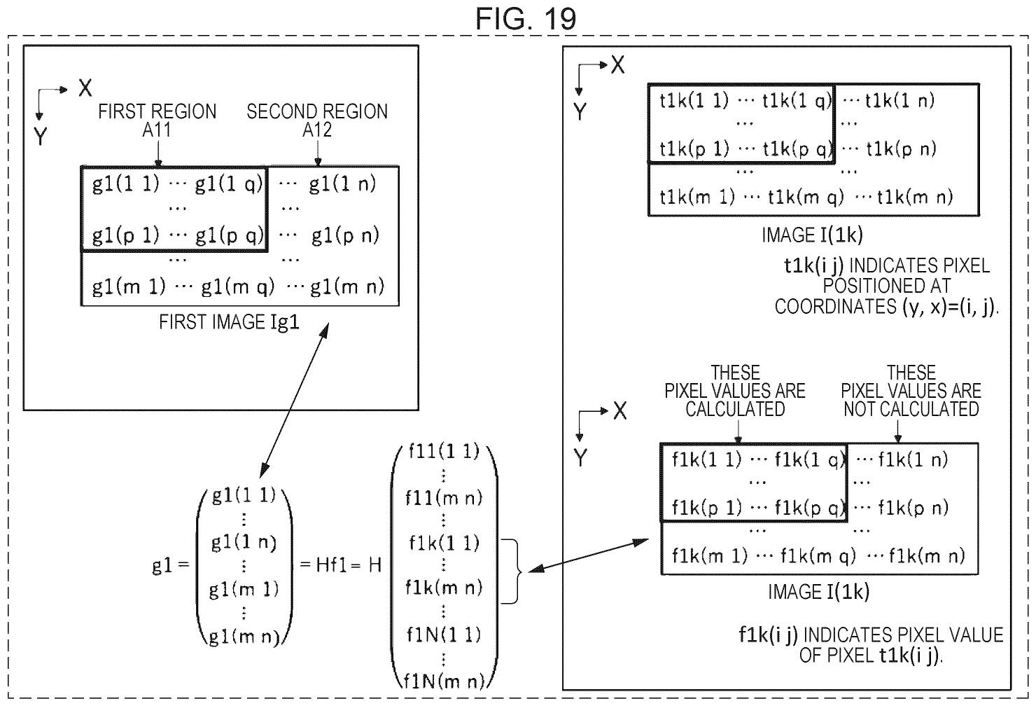

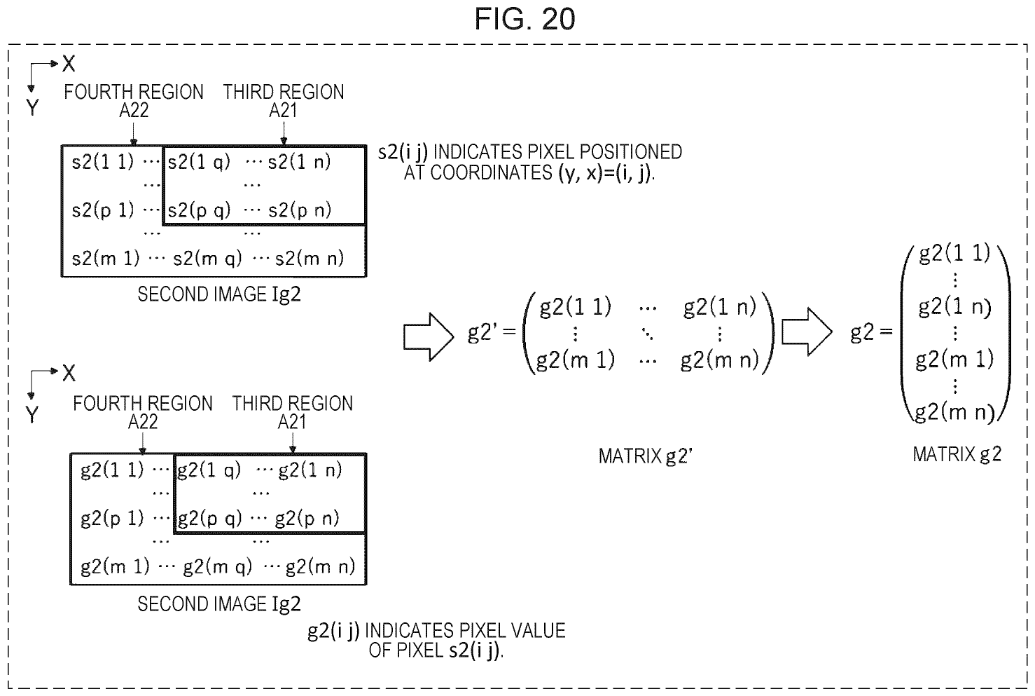

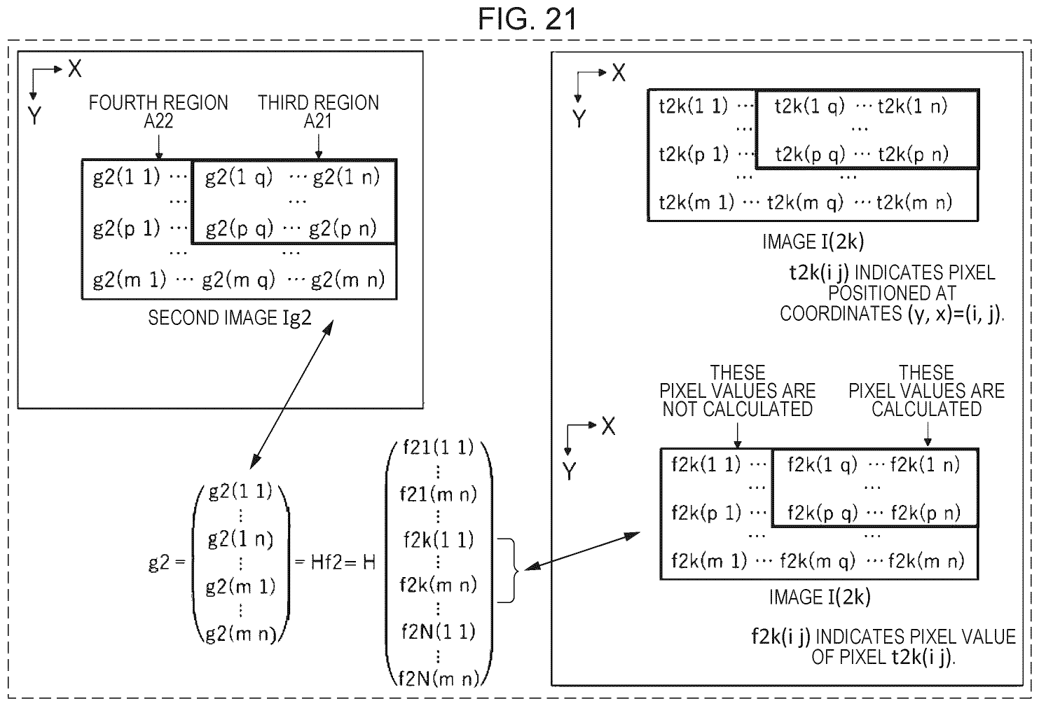

The operation of the imaging system 10 according to the present modification will be described below using FIGS. 17 to 21. FIG. 17 is a flowchart illustrating the operation of the imaging system 10 according to the present modification. FIG. 18 is a diagram illustrating the relationship between a first image Ig1, a matrix g1′, and a matrix g1. FIG. 19 is a diagram illustrating the relationship between the first image Ig1 and an image I(1k). FIG. 20 is a diagram illustrating the relationship between a second image Ig2, a matrix g2′, and a matrix g2. FIG. 21 is a diagram illustrating the relationship between the second image Ig2 and an image I(2k).

The imaging system 10 includes the imaging apparatus 100, the processing apparatus 200, and the storage device 230. The storage device 230 may also be called a memory. The memory may be one or more memories. The imaging apparatus 100 includes the filter array 110 and the image sensor 160.

The filter array 110 includes filters. Transmittance characteristics with respect to the wavelengths corresponding to the filters from the first wavelength to the second wavelength are different from each other (refer to FIGS. 2A to 2D). The lower limit of the target wavelength range W described in the description for FIGS. 3A and 3B may be the first wavelength, and the higher limit thereof may be the second wavelength. For example, in a case where the target wavelength range W is the wavelength range for visible light, the first wavelength may be about 400 nm, and the second wavelength may be about 700 nm.

The processing apparatus 200 includes a processor (not illustrated). The processor may be one or more processors.

The memory stores commands (instructions). The commands are executed by the processor. The commands include processing described in S11000 to S16000 illustrated in FIG. 17.

### S11000

The processor causes the image sensor 160 to capture an image of a target S at a first time. As a result, the image sensor 160 outputs a first image Ig1. The first image Ig1 is based on first light from the filter array 110, and the image sensor 160 receives the first light. The first image Ig1 is stored in the memory. The first light is based on second light incident on the filter array 110 from the target S.

### S12000

The processor determines a first region A11 included in the first image Ig1. The processor may determine the first region A11 on the basis of information specified by the user (for example, refer to S2400 of the first modification of the first embodiment).

The first image Ig1 has m×n pixels. Each of the m×n pixels has a pixel value.

The pixel value of a pixel s1(i j) positioned at (y, x)=(i, j) in the first image Ig1 is g1(i j) (refer to FIG. 18). 1≤ i≤ m, 1≤ j≤n, where i is an integer greater than or equal to 1, j is an integer greater than or equal to 1, n is an integer greater than or equal to 1, and m is an integer greater than or equal to 1.

The first image Ig1 includes the first region A11 and a second region A12. The first region A11 includes the target S. The second region A12 does not include the target S.

The first region A11 includes first pixels, which are s1(1 1), . . . , s1(1 q), . . . , s1(p 1), . . . , s1(p q).

The second region A12 includes second pixels, which are s1(1 q+1), . . . , s1(1 n), . . . , s1(p q+1), . . . , s1(p n), . . . , s1(m 1), . . . , s1(m n).

The first region A11 does not include a region included in the second region A12.

The second region A12 does not include a region included in the first region A11.

The pixel values of the pixels included in the first image Ig1 are expressed by the matrix g1′ having m rows and n columns (refer to FIG. 18).

The pixel values of the pixels included in the first image Ig1 are expressed by the matrix g1 having m×n rows and one column (refer to FIG. 18).

### S13000

The processor performs a first process. The first process is a process in which first pixel values corresponding to third pixels are calculated on the basis of the matrix g1 based on the matrix H and the first image Ig1, and second pixel values corresponding to fourth pixels are not calculated on the basis of the matrix g1 based on the matrix H and the first image Ig1. The first process will be described below.

The processor calculates the first pixel values corresponding to the third pixels on the basis of the matrix g1 based on the matrix H and the first image Ig1 (refer to Eqs. (1) and (2) and FIG. 19).

The third pixels are t1k(1 1), . . . , t1k(1 q), . . . , t1k(p 1), . . . , t1k(p q).

The first pixel values are f1k(1 1), . . . , f1k(1 q), . . . , f1k(p 1), . . . , f1k(p q).

The processor does not calculate the second pixel values corresponding to the fourth pixels on the basis of the matrix g1 based on the matrix H and the first image Ig1 (refer to Eqs. (1) and (2) and FIG. 19).

The fourth pixels are t1k(1 q+1), . . . , t1k(1 n), . . . , t1k(p q+1), . . . , t1k(pn), . . . , t1k(m 1), . . . , t1k(m n).

The second pixel values are f1k(1 q+1), . . . , f1k(1 n), . . . , f1k(p q+1), . . . , f1k(p n), . . . , f1k(m 1), . . . , f1k(m n). Each of the second pixel values may be a predetermined value, such as zero.

The image I(1k) includes the third pixels and the fourth pixels. The third pixels correspond to the first pixels, and the fourth pixels correspond to the second pixels. The image I(1k) corresponds to the k-th wavelength range Wk (refer to FIG. 19).

1≤k≤N (refer to FIGS. 3A and 3B), where k is an integer, and N is an integer. The lowest wavelength included in the k-th wavelength range Wk is greater than or equal to the first wavelength, and the highest wavelength included in the k-th wavelength range Wk is less than or equal to the second wavelength. Images I(11) to I(1N) may all be generated. One image included in the images I(11) to I(1N) may be generated, and the other (N−1) images included in the images I(11) to I(1N) do not have to be generated. α images included in the images I(11) to I(1N) may be generated, and the other (N−α) images included in the images I(11) to I(1N) do not have to be generated. 2≤ α≤ N, where a may be an integer.

### S14000

The processor causes the image sensor 160 to capture an image of the target S at a second time. As a result, the image sensor 160 outputs a second image Ig2. The second image Ig2 is based on third light from the filter array 110, and the image sensor 160 receives the third light. The second image Ig2 is stored in the memory. The third light is based on fourth light incident on the filter array 110 from the target S. The first time and the second time are determined on the basis of a predetermined frame rate. The subtraction of the first time from the second time may be 1/(the frame rate).

### S15000

The processor determines a third region A21 included in the second image Ig2. The processor may determine the third region A21 on the basis of one or more feature points included in the second image Ig2 and one or more feature points included in the region A11 (for example, refer to S2100 and S2200 in the first modification of the first embodiment). The second image Ig2 has m×n pixels. Each of the m×n pixels has a pixel value.

The pixel value of a pixel s2(i j) positioned at (y, x)=(i, j) in the second image Ig2 is g2(i j) (refer to FIG. 20). 1≤ i≤ m, 1≤ j≤n, where i is an integer greater than or equal to 1, j is an integer greater than or equal to 1, n is an integer greater than or equal to 1, and m is an integer greater than or equal to 1.

The second image Ig2 includes the third region A21 and a fourth region A22. The third region A21 includes the target S. The fourth region A22 does not include the target S.

The third region A21 includes fifth pixels, which are s2(1 q), . . . , s2(1 n), . . . , s2(p q), . . . , s2(pn).

The fourth region A22 includes sixth pixels, which are s2(1 1), . . . , s2(1 q−1), . . . , s2(p 1), . . . , s2(pq−1), . . . , s2(m 1), . . . , s2(m n).

The third region A21 does not include a region included in the fourth region A22.

The fourth region A22 does not include a region included in the third region A21.

The pixel values of the pixels included in the second image Ig2 are expressed by the matrix g2′ having m rows and n columns (refer to FIG. 20).

The pixel values of the pixels included in the second image Ig2 are expressed by the matrix g2 having m×n rows and one column (refer to FIG. 20).

### S16000

The processor performs a second process. The second process is a process in which third pixel values corresponding to seventh pixels are calculated on the basis of the matrix g2 based on the matrix H and the second image Ig2, and fourth pixel values corresponding to eighth pixels are not calculated on the basis of the matrix g2 based on the matrix H and the second image Ig2. The second process will be described below.

The processor calculates the third pixel values corresponding to the seventh pixels on the basis of the matrix g2 based on the matrix H and the second image Ig2 (refer to Eqs. (1) and (2) and FIG. 21).

The seventh pixels are t2k(1 q), . . . , t2k(1 n), . . . , t2k(p q), . . . , t2k(p n).

The third pixel values are f2k(1 q), . . . , f2k(1 n), . . . , f2k(p q), . . . , f2k(p n).

The processor does not calculate the fourth pixel values corresponding to the eighth pixels on the basis of the matrix g2 based on the matrix H and the second image Ig2 (refer to Eqs. (1) and (2) and FIG. 21).

The eighth pixels are t2k(1 1), . . . , t2k(1 q−1), . . . , t2k(p 1), . . . , t2k(p q−1), . . . , t2k(m 1), . . . , t2k(m n).

The fourth pixel values are f2k(1 1), . . . , f2k(1 q−1), . . . , f2k(p 1), . . . , f2k(p q−1), . . . , f2k(m 1), . . . , f2k(m n). Each of the fourth pixel values may be a predetermined value, such as zero.

The image I(2k) includes the seventh pixels and the eighth pixels. The seventh pixels correspond to the fifth pixels, and the eighth pixels correspond to the sixth pixels. The image I(2k) corresponds to the k-th wavelength range Wk (refer to FIG. 21).

1≤ k≤N (refer to FIGS. 3A and 3B). Images I(21) to I(2N) may all be generated. One image included in the images I(21) to I(2N) may be generated, and the other (N−1) images included in the images I(21) to I(2N) do not have to be generated. α images included in the images I(21) to I(2N) may be generated, and the other (N−α) images included in the images I(21) to I(2N) do not have to be generated.

The technology of the present disclosure can be widely used in applications where continuous measurement, evaluation, monitoring, or the like is performed using hyperspectral imaging technology. For example, the technology of the present disclosure can be applied to portable terminals, such as smartphones, small video cameras for hand-held use or installation on moving objects or the like, or robots that perform hyperspectral imaging.

What is claimed is:

1. An imaging system comprising:
an imaging apparatus that acquires a compressed image in which information regarding light of four or more wavelength bands from a target is compressed; and
a processing apparatus, wherein
the processing apparatus
extracts a partial region including a region of the target from the compressed image so as to compensate for a relative motion between the target and the imaging apparatus, and
generates spectral images corresponding to wavelength bands, based on data of the partial region of the compressed image.

2. The imaging system according to claim 1, wherein
the imaging apparatus repeatedly acquires the compressed image, and
the processing apparatus detects, based on temporal changes of the compressed images, the relative motion between the target and the imaging apparatus and determines, based on the relative motion, the partial region.

3. The imaging system according to claim 1, wherein
the imaging apparatus includes
a filter array including filters that have different spectral transmittances from each other, and
an image sensor that detects light that has passed through the filter array and outputs a signal representing the compressed image.

4. The imaging system according to claim 3, further comprising:
a storage device that stores matrix data corresponding to the spectral transmittance of the filter array, wherein
the processing apparatus generates the spectral images, based on a portion of the matrix data corresponding to the partial region.

5. The imaging system according to claim 2, wherein
by performing a matching process based on a signal representing a first compressed image output at a first time from the image apparatus and a signal representing a second compressed image output at a second time after the first time from the image apparatus, the processing apparatus extracts the partial region from the second compressed image.

6. The imaging system according to claim 5, wherein
the processing apparatus
generates the spectral images from data of the partial region, based on matrix data corresponding to the spectral transmittance of part of the filter array corresponding to the partial region of the second compressed image.

7. The imaging system according to claim 1, further comprising:
a sensor that detects the relative motion between the target and the imaging apparatus, wherein
the processing apparatus determines the partial region, based on a signal output from the sensor.

8. The imaging system according to claim 7, wherein
the sensor includes at least one of an acceleration sensor or an angular rate sensor, and
the processing apparatus determines, based on the signal output from the sensor, a motion vector of the imaging apparatus and determines, based on the motion vector, the partial region.

9. The imaging system according to claim 1, wherein
the processing apparatus
causes a display to display the compressed image, and
causes the display to display a graphical user interface for allowing a user to specify the target to be subjected to motion compensation in the compressed image.

10. The imaging system according to claim 1, wherein
the processing apparatus
acquires a signal representing the compressed image from the imaging apparatus, extracts the partial region, and repeatedly generates the spectral images, and
generates video data of each of the spectral images.

11. A method executed by a computer, the method comprising:
acquiring, from an imaging apparatus that acquires a compressed image in which information regarding light of four or more wavelength bands from a target is compressed, a signal representing the compressed image;
extracting a partial region including a region of the target from the compressed image so as to compensate for a relative motion between the target and the imaging apparatus; and
generating, based on data of the partial region of the compressed image, spectral images corresponding to wavelength bands.

12. A non-transitory computer readable medium storing a program that causes a computer to perform processing, the processing comprising:
acquiring, from an imaging apparatus that acquires a compressed image in which information regarding light of four or more wavelength bands from a target is compressed, a signal representing the compressed image;
extracting a partial region including a region of the target from the compressed image so as to compensate for a relative motion between the target and the imaging apparatus; and
generating, based on data of the partial region of the compressed image, spectral images corresponding to wavelength bands.
